(19) United States
(12) Patent Application Publication
(10) Pub. No.: US 2026/0132887 A1
(43) Pub. Date: May 14, 2026

(54) REFRACTORY ANCHOR DEVICE AND SYSTEM

(71) Applicant: Brand Shared Services LLC, Atlanta, GA (US)

(72) Inventor: Eduardo Fernando D'ORACIO DE ALMEIDA, League City, TX (US)

(73) Assignee: Brand Shared Services LLC, Atlanta, GA (US)

(21) Appl. No.: 19/386,466

(22) Filed: Nov. 12, 2025

Related U.S. Application Data
(60) Provisional application No. 63/719,959, filed on Nov. 13, 2024.

(51) Int. Cl. F16M 13/02

(52) U.S. Cl. CPC F16M 13/02

(57) ABSTRACT

An anchoring device includes a main body configured to extend around an interior edge of a thermal vessel. The main body includes a mounting element including an inner surface and an outer mounting surface and a first segment extending from the mounting element in a first direction. The first segment includes a first segment outer surface and a first segment inner surface. The main body includes a second segment extending from the mounting element. The second segment includes a mounting portion extending in a second direction from the mounting element and an extension portion extending from the mounting portion in a third direction. The second segment includes a second segment outer surface extending along the mounting portion and the extension portion and a second segment inner surface extending along the inner portion and the extension portion.

### CROSS-REFERENCE TO RELATED APPLICATION

This application claims the benefit of and priority to U.S. Provisional Application No. 63/719,959, filed November 13, 2024, the entire disclosure of which is hereby incorporated by reference herein.

### BACKGROUND

Thermal-process vessels used in oil refineries and other petrochemical and chemical process facilities have highly abrasive and high-temperature environments. To protect the vessel shells (e.g., sidewalls), their internal surface is typically lined with a refractory material such as a thin layer of concrete.

### SUMMARY

One embodiment relates to an anchoring device for a refractory material for lining a thermal vessel. The anchoring device includes a main body having an L-shape configured to extend at least partially around an interior edge of the thermal vessel. The main body includes a mounting element including an inner surface and an outer mounting surface and a first segment extending from the mounting element in a first direction. The first segment includes a first segment outer surface and a first segment inner surface. The main body includes a second segment extending from the mounting element. The second segment includes a mounting portion extending in a second direction from the mounting element, the second direction opposite the first direction, and an extension portion extending from the mounting portion in a third direction. The third direction is different from the second direction. The second segment includes a second segment outer surface extending along the mounting portion and the extension portion and a second segment inner surface extending along the inner portion and the extension portion. The inner surface, the first segment inner surface, and a section of the second segment inner surface form a planar inner surface. The inner surface, the first segment, and the second segment are disposed in a plane.

Another embodiment an anchoring device for a refractory material for lining a thermal vessel. The anchoring device includes a main body configured to extend at least partially around an interior edge of the thermal vessel. The main body includes a mounting element having an inner surface and an outer mounting surface, and a first segment extending from the mounting element. The first segment includes a first mounting portion extending in a first direction from the mounting element, a first branch portion extending from the first mounting portion at an obtuse angle relative to the first mounting portion, and a first end portion extending from the first branch portion parallel with the first mounting portion. The main body includes a second segment extending from the mounting element. The second segment includes a second mounting portion that extends in a second direction from the mounting element, the second direction opposite the first direction. The second mounting portion includes a bend, an extension portion extending from the first mounting portion in a third direction, a second branch portion extending from the extension portion at an obtuse angle relative to the extension portion, and a second end portion extending from the second branch portion parallel with the extension portion. The mounting element, the first mounting portion, the second mounting portion, and the extension portion are disposed in a plane.

Another embodiment relates to an anchoring device for a refractory material for lining a thermal vessel. The anchoring device includes a main body configured to extend at least partially around an interior edge of the thermal vessel. The main body includes a mounting element having an inner surface and an outer mounting surface and a first segment extending from the mounting element. The first segment includes a first mounting portion extending in a first direction from the mounting element, a plurality of first branch portions extending from the first mounting portion at an obtuse angle relative to the first mounting portion, and a plurality of first end portions. Each of the end portions extending from a corresponding one of the plurality of first branch portions. The plurality of first end portions extends parallel with the first mounting portion. The main body includes a second segment extending from the mounting element. The second segment includes a second mounting portion extending in a second direction from the mounting element, the second direction opposite the first direction, a bend, and an extension portion extending from the first mounting portion in a third direction. A plurality of second branch portions extend from the extension portion at an obtuse angle relative to the extension portion. A plurality of second end portions each extend from a corresponding second branch portion of the plurality of second branch portions. The plurality of second end portions extend parallel with the extension portion. The mounting element, the first mounting portion, the second mounting portion, and the extension portion are disposed in a plane.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a perspective view of an example refractory anchor, according to an example embodiment.

FIG. 2 is a bottom perspective view of the refractory anchor of FIG. 1.

FIG. 3 is a side view of the refractory anchor of FIG. 1.

FIG. 4 is a rear view of the refractory anchor of FIG. 1.

FIG. 5 is a bottom view of the refractory anchor of FIG. 1.

FIG. 6 is a perspective view of another example refractory anchor, according to an example embodiment.

FIG. 7 is a bottom perspective view of the refractory anchor of FIG. 6.

FIG. 8 is a side view of the refractory anchor of FIG. 6.

FIG. 9 is a rear view of the refractory anchor of FIG. 6.

FIG. 10 is a bottom view of the refractory anchor of FIG. 6.

FIG. 11 is a perspective view of another example refractory anchor, according to an example embodiment.

FIG. 12 is a bottom perspective view of the refractory anchor of FIG. 11.

FIG. 13 is a side view of the refractory anchor of FIG. 11.

FIG. 14 is a rear view of the refractory anchor of FIG. 11.

FIG. 15 is a bottom view of the refractory anchor of FIG. 11.

FIG. 16 is a perspective view of another example refractory anchor, according to an example embodiment.

FIG. 17 is a side view of the refractory anchor of FIG. 16.

FIG. 18 is a bottom view of the refractory anchor of FIG. 16.

FIG. 19 is a perspective view of another example refractory anchor, according to an example embodiment.

FIG. 20 is a side view of the refractory anchor of FIG. 19.

FIG. 21 is a bottom view of the refractory anchor of FIG. 19.

FIG. 22 is a perspective view of another example refractory anchor, according to an example embodiment. 108

FIG. 23 is a side view of the refractory anchor of FIG. 22.

FIG. 24 is a bottom view of the refractory anchor of FIG. 22.

FIG. 25 is a cross-sectional view of an example mounting element, according to an example embodiment.

FIG. 26 is a bottom perspective view of an example mounting element, according to an example embodiment.

FIG. 27 is a perspective view of an example array of refractory anchors of FIG. 6, according to an example embodiment.

FIG. 28 is a perspective view of an example array of refractory anchors of FIG. 11, according to an example embodiment.

FIG. 29 is a perspective view of an example array of refractory anchors of FIG. 16, according to an example embodiment.

FIG. 30 is a perspective view of an example array of refractory anchors of FIG. 19, according to an example embodiment.

FIG. 31 is a perspective view of an example array of refractory anchors of FIG. 22, according to an example embodiment.

FIG. 32 is a perspective view of another example refractory anchor, according to an example embodiment.

FIG. 33 is a side view of the refractory anchor of FIG. 32.

FIG. 34 is a side view of the refractory anchor of FIG. 32 alongside an interior corner of a thermal vessel, according to an example embodiment.

FIG. 35 is a is a perspective view of another example refractory anchor, according to an example embodiment.

FIG. 36 is a side view of the refractory anchor of FIG. 35.

FIG. 37 is a side view of the refractory anchor of FIG. 35 alongside an interior corner of a thermal vessel, according to an example embodiment.

FIG. 38 is a is a perspective view of another example refractory anchor, according to an example embodiment.

FIG. 39 is a side view of the refractory anchor of FIG. 38.

FIG. 40 is a side view of the refractory anchor of FIG. 38 alongside an interior corner of a thermal vessel, according to an example embodiment.

### DETAILED DESCRIPTION

Following below are more detailed descriptions of various concepts related to, and implementations of, methods, apparatuses, and systems of anchoring devices for a refractory material for together forming a protective barrier system for a thermal vessel. The various concepts introduced above and discussed in greater detail below may be implemented in any of numerous ways.

The most common form of thin-layer abrasion-resistant refractory concrete anchoring system is called HEXMESH (aka “hexmetal” or just “hex”) anchor sheets. Hex includes a series of steel strips that are interlocked (i.e., “clinched” together by a tab-and-slot arrangement) to form a sheet or mat of hexagonal cells in a honeycomb-patterned array or grid. The hex sheets are installed by fitting (bending/shaping and cutting/sizing) them to whatever vessel shape and size is to be lined and then welding them in place by a large number of welds to create a strong attachment to the underlying vessel shell. Once welded, mixed refractory concrete is then rammed, beaten, or packed into the hex cells. The refractory concrete and hex sheet together form a barrier system that protects the underlying vessel shell from heat, abrasion, and chemical attack.

Over the decades that hex has been in use, several weaknesses in this system have been exposed. The hex and refractory system must move in concert with any flex that occurs in the vessel shell because the hex sheet is fitted and welded flush with and rigidly to the vessel shell. This makes the hex and refractory system prone to “biscuiting,” which means individual hex cells will tend to “pop” the refractory concrete out in a hexagonal biscuit shape when the vessel shell experiences thermal expansion or contraction. In addition, this can compromise the protective capabilities of the refractory concrete liner by opening gaps that allow catalysts, gases, carbon, and other process-related materials to contact the exposed portion of the vessel shell. This in turn can lead to further failure of the refractory concrete liner system and the need for premature replacement of extremely expensive process vessels and components. Furthermore, installing hex is very time-consuming, tedious, and cumbersome because of the large number of welds required and because the sheets must be cut on-site to custom-fit each vessel, beat into shape and place with a hammer, and sometimes cut into small pieces to fit through access openings to the work areas, with this being particularly an issue for irregularly shaped vessels.

Other refractory anchoring devices and systems include D-BAR anchors (e.g., U.S. Pat. No. 6,393,789), C-BAR anchors, and G3 anchors. Some of these are provided in sheet form and thus must by bent and cut to fit the individual vessel in the same manner as the HEXMESH sheets. And some of these include multiple parts that are interlocked together with a clinching system in the same manner as the HEXMESH sheets. As such, these other refractory anchoring devices and systems include some or all of the same drawbacks.

Accordingly, it can be seen that needs exist for improvements in anchoring devices, systems, and methods for refractory liners for thermal vessels. It is to the provision of solutions to these and other problems that the present disclosure is primarily directed.

Generally described, the present invention relates to anchoring devices, systems, and methods for a refractory material for together forming a protective barrier system for a thermal vessel. The anchoring devices, systems, and methods can be used for protecting thermal vessels such as high-temperature cyclone separators (e.g., fluid catalytic crackers aka FCCs), burners, furnaces, columns, and tanks, piping for these, and other high-temperature industrial-process containers. These thermal vessels operate at high temperatures of typically about 250 C to about 1800 C. The anchoring devices, systems, and methods can be used for protecting such thermal vessels in oil refineries, other petrochemical-process facilities, chemical-process facilities, chemical-manufacturing plants, cement plants, fertilizer plants, steel mills, pulp-and-paper plants, power- generating plants, and other facilities and industries using such high-temperature vessels. And the anchoring devices, systems, and methods can be used for anchoring refractory materials including concrete, fibers, plastics, ceramics, and/or other conventional refractories, typically applied in a viscous state and cured on site, but in some embodiments precast or otherwise pre-formed.

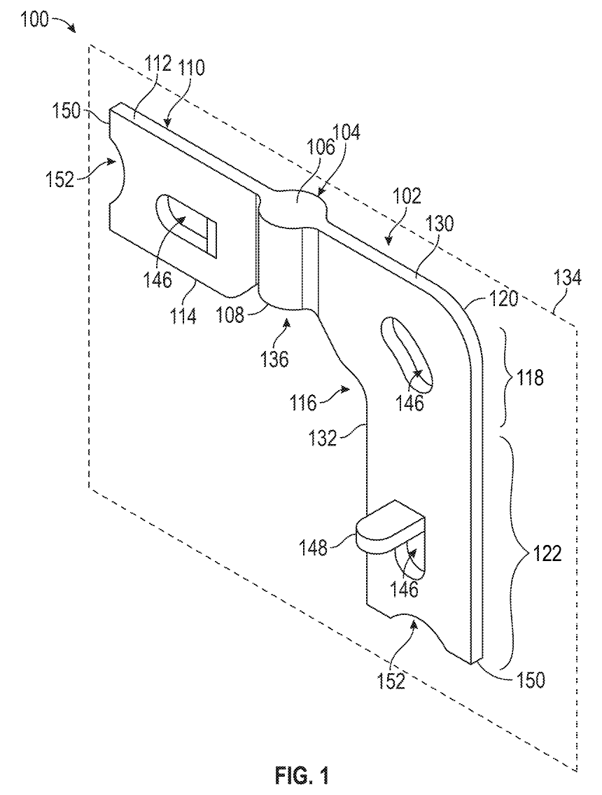

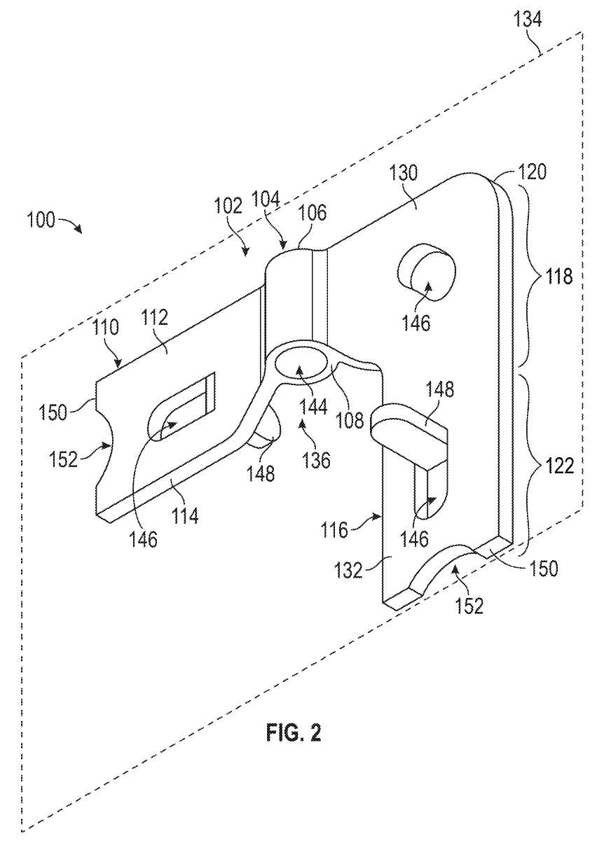

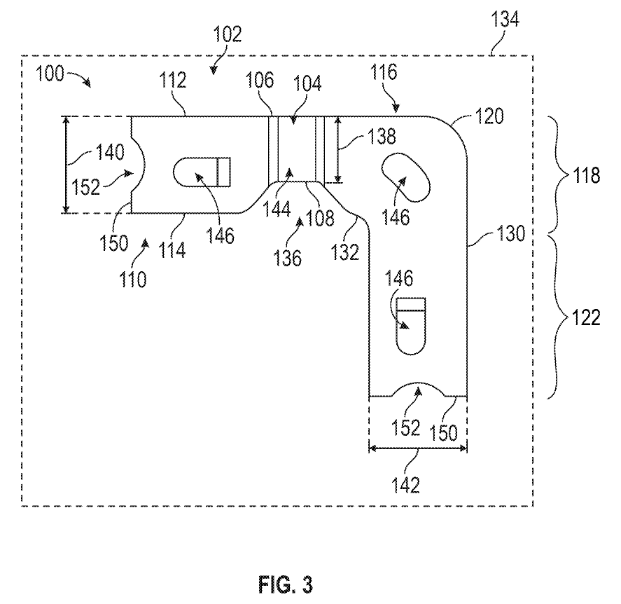

Referring to FIGS. 1-5, an example refractory anchor 100 is shown, according to an example embodiment. The refractory anchor 100 includes a main body 102. The main body 102 is configured to extend at least partially around an edge of a thermal vessel. The main body 102 is shown to include an L-shape arrangement end-to-end. For example, the main body 102 may have a first portion extending in a first direction and a second portion extending from an end of the first portion at approximately a right angle to create an L-shape. The main body 102 includes a mounting element 104. The mounting element 104 may be configured to couple the refractory anchor 100 with a thermal vessel. The mounting element 104 is shown to include a first surface, shown as outer mounting surface 106, and a second surface, shown as inner mounting surface 108. The outer mounting surface 106 is opposite the inner mounting surface 108. The inner mounting surface 108 is configured to confront or engage a mounting surface of the thermal vessel.

The main body 102 includes a first segment 110. The first segment 110 may extend from the mounting element 104 in a first direction. The first segment 110 is a straight (e.g., linear) segment extending away from the mounting element 104. The first segment 110 may be coupled with or integrally formed with the mounting element 104. The first segment 110 may be the same material as or a different material than the mounting element. The first segment 110 includes a first segment outer surface 112 and a first segment inner surface 114. The first segment outer surface 112 is opposite the first segment inner surface 114. The first segment inner surface 114 is configured to confront the mounting surface of the thermal vessel.

The main body 102 includes a second segment 116. The second segment 116 extends from the mounting element 104. The second segment 116 may be coupled with or integrally formed with the mounting element 104. The second segment 116 may be the same material as or a different material than the mounting element. The second segment 116 is shown to include a mounting portion 118. The mounting portion 118 may extend from the mounting element 104 in a second direction. The second direction may be opposite the first direction of the first segment 110. The mounting portion 118 is shown to include a bend 120.

The second segment 116 is shown to include an extension portion 122. The extension portion 122 may extend from the mounting portion 118 in a third direction. The third direction may be different than the second direction. For example, the third direction may be perpendicular to the second direction.

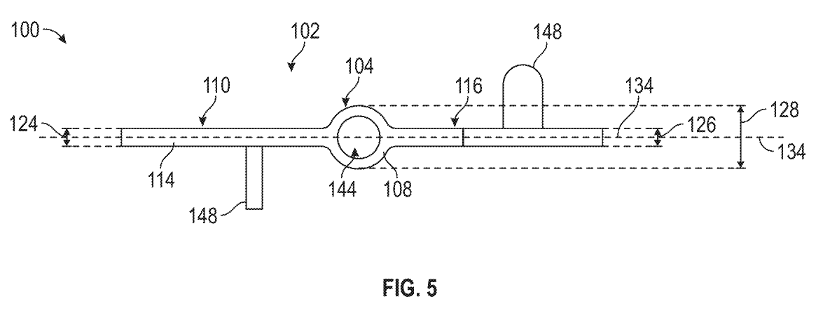

The various portions of the second segment 116 may be coupled together or formed from a single component, or a combination thereof. For example, the second segment 116 may be a single piece of material with a plurality of bends to orient the portions in a desired orientation. As shown in FIG. 5, among others, the first segment 110 and the second segment 116 may comprise a thin profile. For example, the first segment 110 and the second segment 116 may comprise a single sheet or layer of material. The first segment 110 may have a first segment width 124. The second segment 116 may have a second segment width 126. The first segment width 124 may be the same as or different than the second segment width 126. The mounting element 104 may have a mounting element width 128. The mounting element width 128 may be greater than both the first segment width 124 and the second segment width 126.

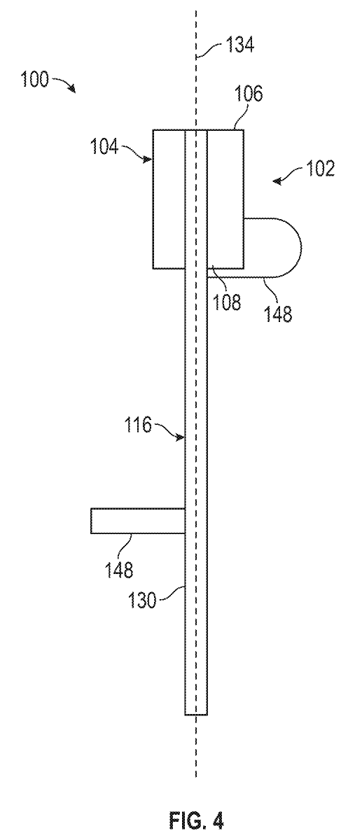

The second segment 116 is shown to include a second segment outer surface 130 and a second segment inner surface 132. The second segment outer surface 130 may extend along the mounting portion 118 and the extension portion 122. The second segment inner surface 132 may extend along the mounting portion 118 and the extension portion 122. The first segment outer surface 112, the outer mounting surface 106, and a section of the second segment outer surface 130 may form a planar outer surface. As shown in FIG. 4, among others, the first segment 110, the mounting element 104, and the second segment 116 may be disposed in a plane 134.

In some embodiments, the first segment inner surface 114, the inner mounting surface 108, and the second segment inner surface 132 may define a pocket 136. The pocket 136 may be configured to receive at least a portion of a stud. The pocket 136 may allow for a larger stud to be used, which may improve the connection between the refractory anchor 100 and the thermal vessel. With the pocket 136, a mounting element depth 138 may be less than a first segment depth 140 (e.g., a maximum first segment depth 140) and less than a second segment depth 142 (e.g., a maximum second segment depth 142). The first segment depth 140 may be the same as or different than the second segment depth 142.

The mounting element 104 includes a recess 144. The recess 144 is configured to receive a first portion of a stud. The stud is configured to couple the refractory anchor 100 with the thermal vessel. The inner mounting surface 108 may be configured to interface with a second portion of the stud (e.g., a shoulder of the stud). At least a portion of the stud is disposed in the pocket 136. In some embodiments, the mounting element 104 may be integrally formed with the stud.

The refractory anchor 100 is shown to include at least one opening or aperture, shown as void 146. The void 146 may extend through a portion of the main body 102. The void 146 may be configured to allow refractory to flow through the main body 102 when the refractory anchor 100 is mounted to the thermal vessel and the refractory is being installed. The main body 102 is shown to include a plurality of voids 146. For example, the first segment 110 is shown to include a first void 146. The second segment 116 is shown to include a second void 146 and a third void 146. The second void 146 may be disposed on the mounting portion 118. The third void 146 may be disposed on the extension portion 122.

The main body 102 is shown to include at least one reinforcement segment, shown as tab 148. The tab 148 may correspond with a void 146. In some embodiments, the tabs 148 may be linear and extend away from the main body 102. The tabs 148 may provide additional contact surface area for engaging and securing the refractory in place. The tabs 148 may protrude from the main body 102 to reduce unobstructed distances within the refractory, thereby better securing the refractory in the cells and helping reduce the likely incidence of biscuiting of the refractory. In some embodiments, the tabs 148 extend at an acute angle, at an obtuse angle, or perpendicular to the corresponding segment. In some embodiments, the refractory anchor 100 has no tabs 148, or a subset of the voids 146 have tabs 148.

In some embodiments, the main body 102 may have at least one segment end 150. The segment end 150 may be disposed at an end of the first segment 110 or the second segment 116. The segment end 150 is shown to include at least one indented region 152. The indented region 152 may have a curved surface.

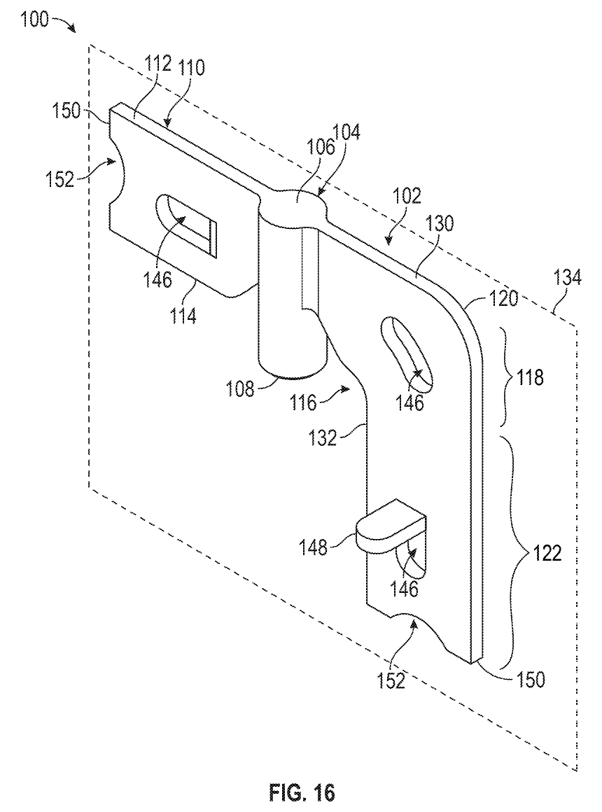

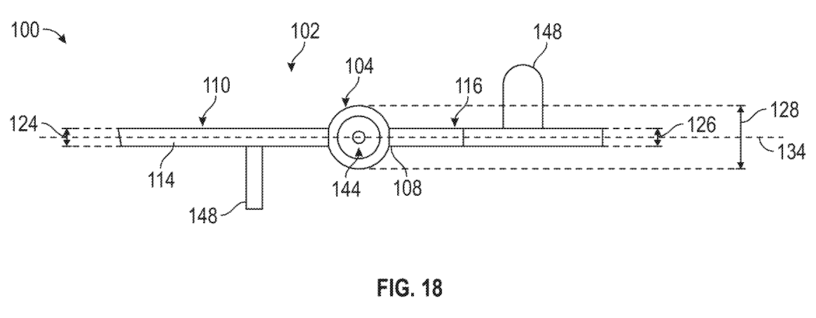

Referring to FIGS. 16-18, in some embodiments the recess 144 and the pocket 136 are omitted, and the mounting element 104 may define a longer length or height (e.g., the mounting element depth 138 of FIGS. 16-18 is greater than the mounting element depth 138 of FIGS. 1-5). For example, the mounting element depth 138 may be greater than the first segment depth 140 and greater than the second segment depth 142. In this embodiment, the inner mounting surface 108 of the mounting element 104 is configured to couple to the mounting surface of the thermal vessel. That is, rather than using a separate stud that is coupled to the mounting element 104 and then welded to the thermal vessel, the mounting element 104 is welded directly to the thermal vessel.

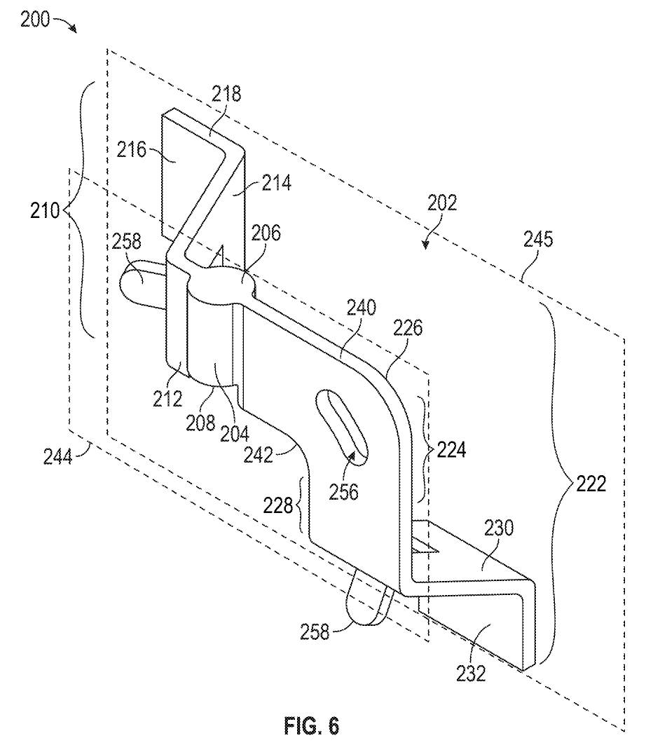

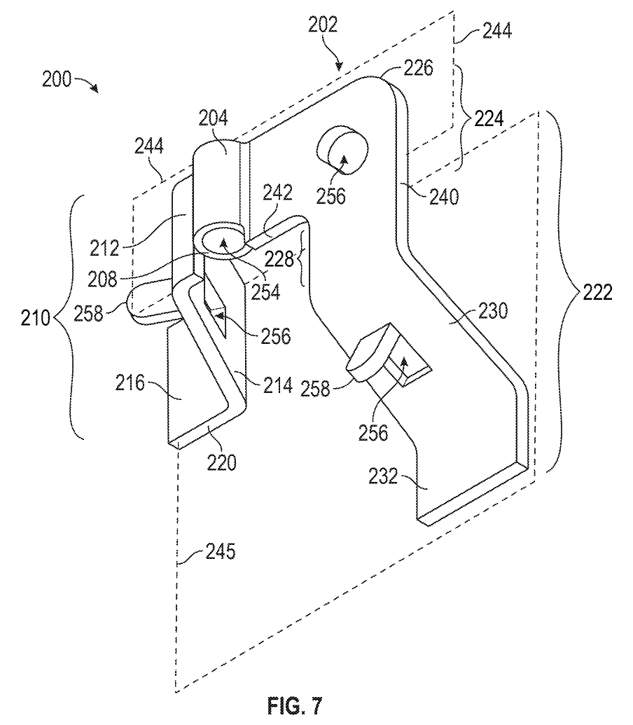

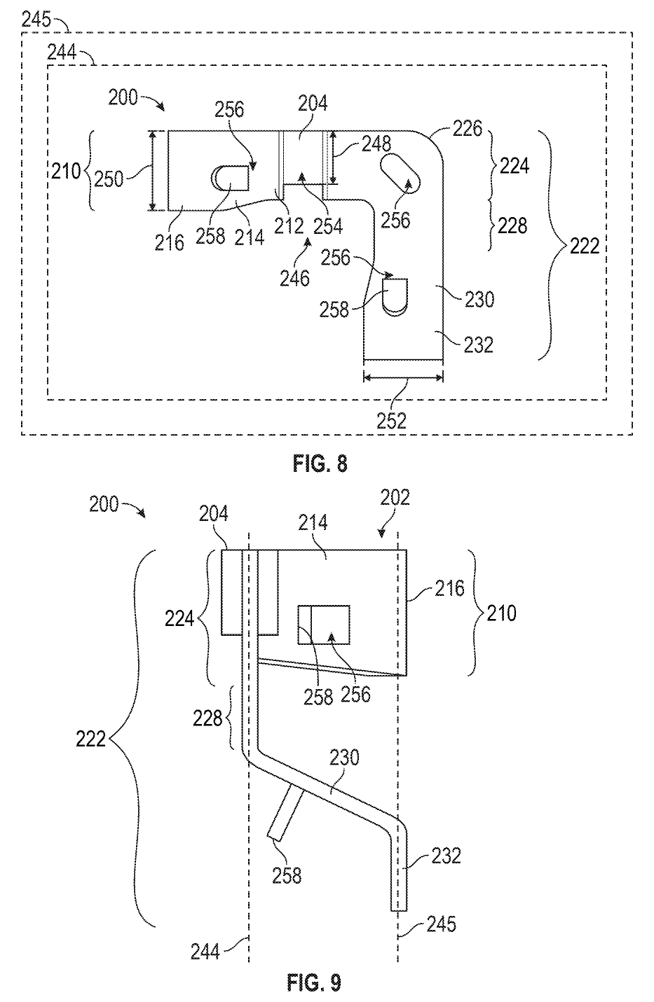

Referring to FIGS. 6-10, an example refractory anchor 200 is shown, according to an example embodiment. The refractory anchor 200 includes a main body 202. The main body 202 is configured to extend at least partially around an edge of a thermal vessel. The main body 202 includes a mounting element 204. The mounting element 204 may be configured to couple the refractory anchor 200 with a thermal vessel. The mounting element 104 is shown to include a first surface, shown as outer mounting surface 206, and a second surface, shown as inner mounting surface 208. The outer mounting surface 206 is opposite the inner mounting surface 208. The inner mounting surface 208 is configured to confront the mounting surface of the thermal vessel.

The main body 202 includes a first segment 210. The first segment 210 may extend from the mounting element 204. The first segment 210 is a non-linear (e.g., bent, curvy, etc.) segment extending away from the mounting element 204. The first segment 210 may be coupled with or integrally formed with the mounting element 204. The first segment 210 may be the same material as or a different material than the mounting element 204.

The first segment 210 is shown to include a first mounting portion 212. The first mounting portion 212 may extend in a first direction from the mounting element 204. The first segment 210 is shown to include a first branch portion 214. The first branch portion 214 may extend from the first mounting portion 212 at an obtuse angle relative to the first mounting portion 212. The first segment 210 is shown to include a first end portion 216. The first end portion 216 may extend from the first branch portion 214 parallel with the first mounting portion 212. The first segment 210 is shown to include a first segment outer surface 218 and a first segment inner surface 220. The first segment outer surface 218 is opposite the first segment inner surface 220. The first segment inner surface 218 is configured to confront the mounting surface of the thermal vessel. The first segment outer surface 218 may extend along the first mounting portion 212, the first branch portion 214, and the first end portion 216. The first segment inner surface 220 may extend along the first mounting portion 212, the first branch portion 214, and the first end portion 216.

The main body 202 includes a second segment 222. The second segment 222 extends from the mounting element 204. The second segment 222 may be coupled with or integrally formed with the mounting element 204. The second segment 222 may be the same material as or a different material than the mounting element 204. The second segment 222 is shown to include a second mounting portion 224. The second mounting portion 224 may extend in a second direction from the mounting element 204. The second direction may be opposite the first direction of the first mounting portion 212. The second mounting portion 224 is shown to include a bend 226. The second segment 222 is shown to include an extension portion 228. The extension portion 228 may extend from the second mounting portion 224 in a third direction. The third direction may be different than the second direction. For example, the third direction may be perpendicular to the second direction. The second segment 222 is shown to include a second branch portion 230. The second branch portion 230 may extend from the extension portion 228 at an obtuse angle relative to the extension portion 228. The second segment 222 is shown to include a second end portion 232. The second end portion 232 may extend from the second branch portion 230 parallel with the extension portion 228.

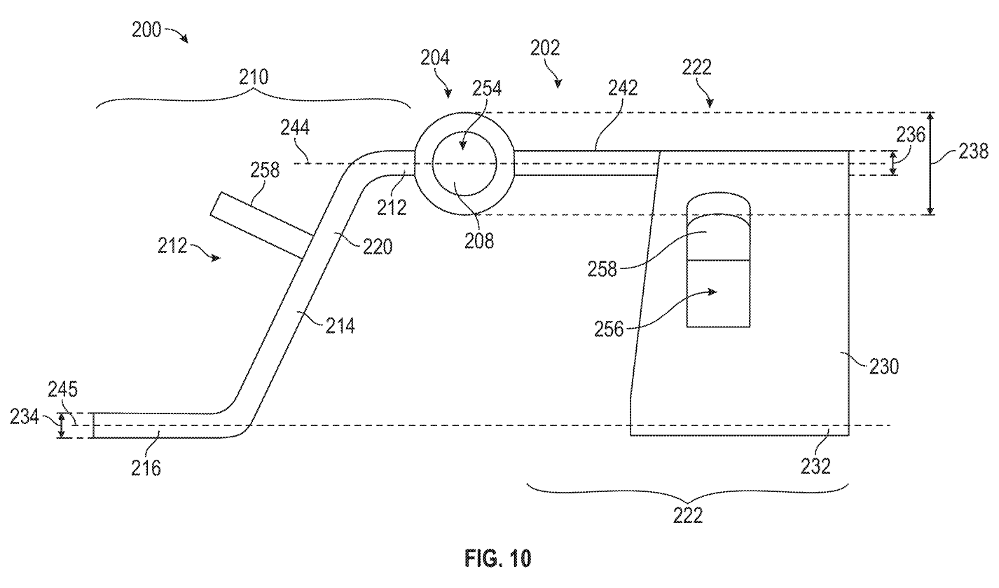

The various portions of the first segment 210 and the second segment 222 may be coupled together or formed from a single component, or a combination thereof. For example, the first segment 210 or the second segment 222 may be a single piece of material with a plurality of bends to orient the portions in a desired orientation. As shown in FIG. 10, among others, the first segment 210 and the second segment 222 may comprise a thin profile. For example, the first segment 210 and the second segment 222 may comprise a single sheet or layer of material. The first segment 210 may have a first segment width 234. The second segment 222 may have a second segment width 236. The first segment width 234 may be the same as or different than the second segment width 236. The mounting element 204 may have a mounting element width 238. The mounting element width 238 may be greater than both the first segment width 234 and the second segment width 236.

The second segment 222 is shown to include a second segment outer surface 240. The second segment outer surface 240 may extend along the second mounting portion 224, the extension portion 228, the second branch portion 230, and the second end portion 232. The second segment 222 is shown to include a second segment inner surface 242. The second segment inner surface 242 may extend along the second mounting portion 224, the extension portion 228, the second branch portion 230, and the second end portion 232. The outer mounting surface 206, the first segment outer surface 218, and a portion of the second segment outer surface 240 may form a planar outer surface. As shown in FIG. 10, among others, the mounting element 204, the first mounting portion 212, the second mounting portion 224, and the extension portion 228 may be disposed in a first plane 244. As shown in FIG. 9, the first end portion 216 and the second end portion 232 may be disposed in a second plane 245. The second plane 245 may be offset from and parallel with the first plane 244.

In some embodiments, the first segment inner surface 220, the inner mounting surface 208, and the second segment inner surface 242 defines a pocket 246. The pocket 246 is configured to receive at least a portion of a stud. The pocket 246 may allow for a larger stud to be used, which may improve the connection between the refractory anchor 200 and the thermal vessel. With the pocket 246, a mounting element depth 248 may be less than a first segment depth 250 (e.g., a maximum first segment depth 250) and less than a second segment depth 252 (e.g., a maximum second segment depth 252). The first segment depth 250 may be the same as or different than the second segment depth 252.

The mounting element 204 is shown to include a recess 254. The recess 254 may be configured to receive a first portion of a stud. The stud may be configured to couple the refractory anchor 200 with the thermal vessel. The inner mounting surface 208 may be configured to interface with a second portion of the stud (e.g., a shoulder of the stud). At least a portion of the stud may be disposed in the pocket 246. In some embodiments, the mounting element 204 may be integrally formed with the stud.

The refractory anchor 200 is shown to include at least one opening or aperture, shown as void 256. The void 256 may extend through a portion of the main body 202. The void 256 may be configured to allow refractory to flow through the main body 202 when the refractory anchor 200 is mounted to the thermal vessel and the refractory is being installed. The main body 202 is shown to include a plurality of voids 256. For example, the first segment 210 is shown to include a first void 256. The second segment 222 is shown to include a second void 256 and a third void 256. The second void 256 may be disposed on the second mounting portion 224. The third void 256 may be disposed on the second branch portion 230.

The main body 202 is shown to include at least one reinforcement segment, shown as tab 258. The tab 258 may correspond with a void 256. In some embodiments, the tabs 258 may be linear and extend away from the main body 202. The tabs 258 may provide additional contact surface area for engaging and securing the refractory in place. The tabs 258 may protrude from the main body 202 to reduce unobstructed distances within the refractory, thereby better securing the refractory in the cells and helping reduce the likely incidence of biscuiting of the refractory. In some embodiments, the tabs 258 extend perpendicular to the corresponding segment. In some embodiments, the refractory anchor 200 has no tabs 258, or a subset of the voids 256 have tabs 258.

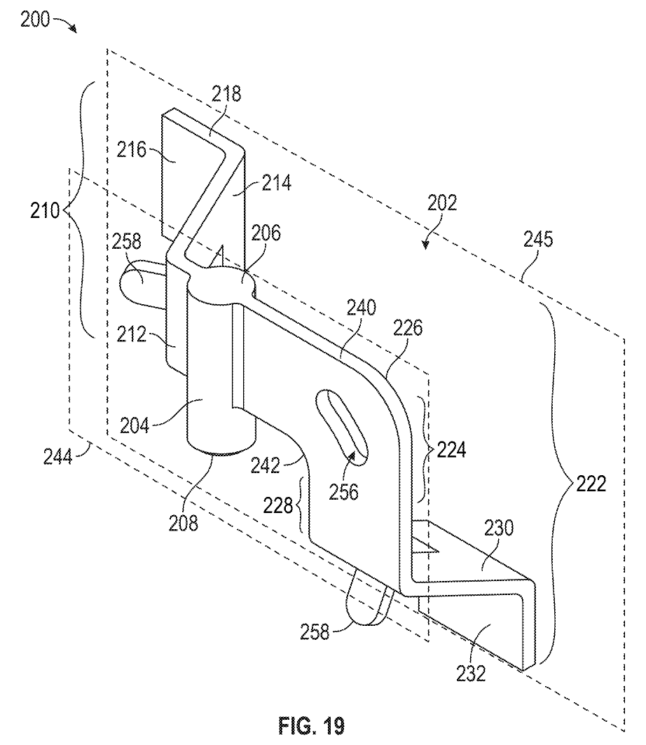

Referring now to FIGS. 19-21, in some embodiments the recess 254 and the pocket 246 are omitted, and the mounting element 204 may define a longer length or height (e.g., mounting element depth 248 of FIGS. 19-21 is greater than the mounting element depth 248 of FIGS. 6-10). For example, the mounting element depth 248 may be greater than the first segment depth 250 and greater than the second segment depth 252. In this embodiment, the inner mounting surface 208 of the mounting element 204 is configured to couple to the mounting surface of the thermal vessel. That is, rather than using a separate stud that is coupled to the mounting element 204 and then welded to the thermal vessel, the mounting element 204 is welded directly to the thermal vessel.

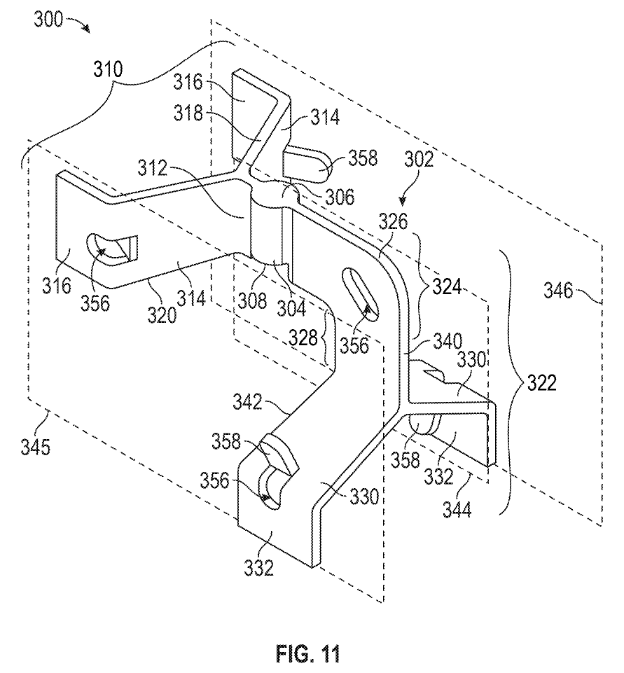

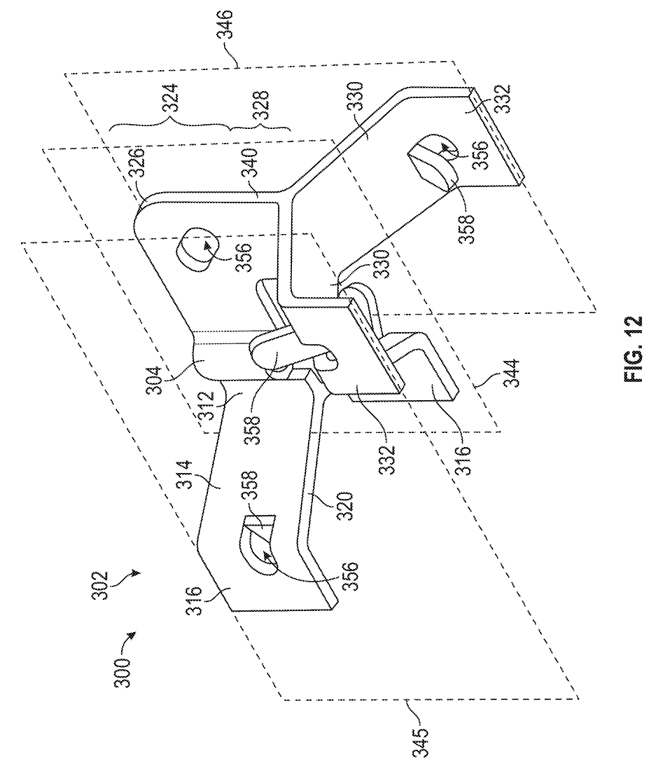

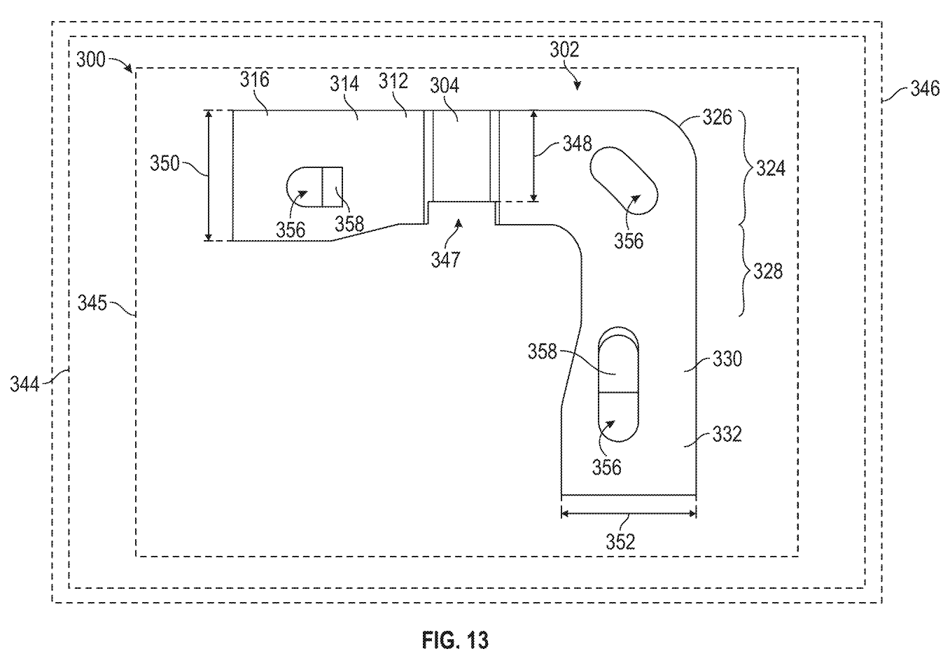

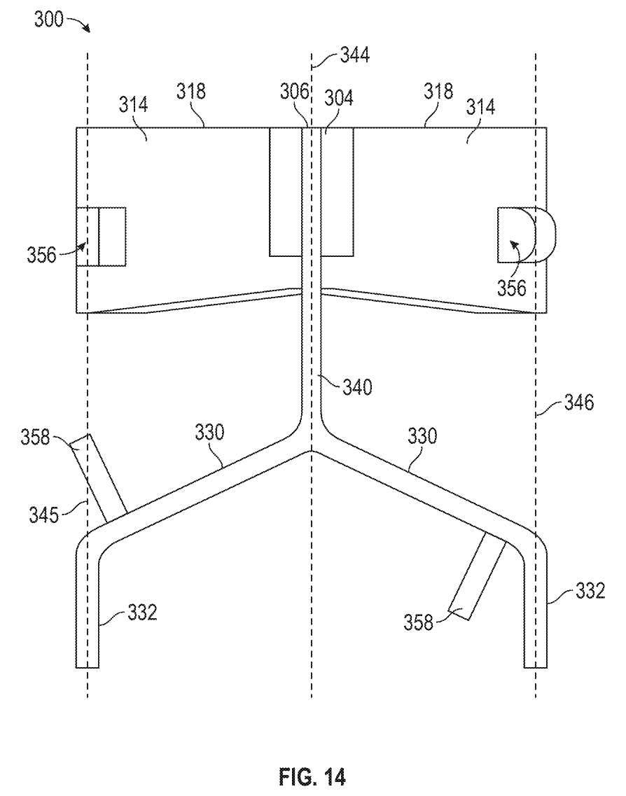

Referring to FIGS. 11-15, an example refractory anchor 300 is shown, according to an example embodiment. The refractory anchor 300 includes a main body 302. The main body 302 is configured to extend at least partially around an edge of a thermal vessel. The main body 302 includes a mounting element 304. The mounting element 304 may be configured to couple the refractory anchor 300 with a thermal vessel. The mounting element 304 is shown to include a first surface, shown as outer mounting surface 306, and a second surface, shown as inner mounting surface 308. The outer mounting surface 306 is opposite the inner mounting surface 308. The inner mounting surface 308 is configured to confront the mounting surface of the thermal vessel.

The main body 302 includes a first segment 310. The first segment 310 may extend from the mounting element 304. The first segment 310 is a non-linear (e.g., bent, curvy, etc.) segment extending away from the mounting element 304. The first segment 310 may be coupled with or integrally formed with the mounting element 304. The first segment 310 may be the same material as or a different material than the mounting element 304.

The first segment 310 is shown to include a first mounting portion 312. The first mounting portion 312 may extend in a first direction from the mounting element 304. The first segment 310 is shown to include a plurality of first branch portions 314. The first branch portions 314 may extend from the first mounting portion 312 at an obtuse angle relative to the first mounting portion 212. For example, one of the first branch portions 314 may extend from the first mounting portion 312 in a first direction at the obtuse angle and another of the first branch portions 314 may extend from the first mounting portion 312 in a second direction at the obtuse angle. The first segment 310 is shown to include a plurality of first end portions 316. Each of the first end portions 316 may extend from a corresponding first branch portion 314. The first end portions 316 may extend parallel with the first mounting portion 312. The first segment 310 is shown to include a first segment outer surface 318 and a first segment inner surface 320. The first segment outer surface 318 is opposite the first segment inner surface 320. The first segment inner surface 320 is configured to confront the mounting surface of the thermal vessel. The first segment outer surface 318 may extend along the first mounting portion 312, the first branch portions 314, and the first end portions 316. The first segment inner surface 320 may extend along the first mounting portions 212, the first branch portions 314, and the first end portions 316.

The main body 302 includes a second segment 322. The second segment 322 extends from the mounting element 304. The second segment 322 may be coupled with or integrally formed with the mounting element 304. The second segment 322 may be the same material as or a different material than the mounting element 304. The second segment 322 is shown to include a second mounting portion 324. The second mounting portion 324 may extend in a second direction from the mounting element 304. The second direction may be opposite the first direction of the first mounting portion 312. The second mounting portion 324 is shown to include a bend 326. The second segment 322 is shown to include an extension portion 328. The extension portion 328 may extend from the second mounting portion 324 in a third direction. The third direction may be different than the second direction. For example, the third direction may be perpendicular to the second direction.

The second segment 322 is shown to include a plurality of second branch portions 330. The second branch portions 330 may extend from the extension portion 328 at an obtuse angle relative to the extension portion 328. For example, one of the second branch portions 330 may extend from the extension portion 328 in a first direction at the obtuse angle and another one of the second branch portions 330 may extend from the extension portion 328 in a second direction at the obtuse angle. The second segment 322 is shown to include a plurality of second end portions 332. Each of the second end portions 332 may extend from a corresponding second branch portion 330. The second end portions 332 may extend parallel with the extension portion 328.

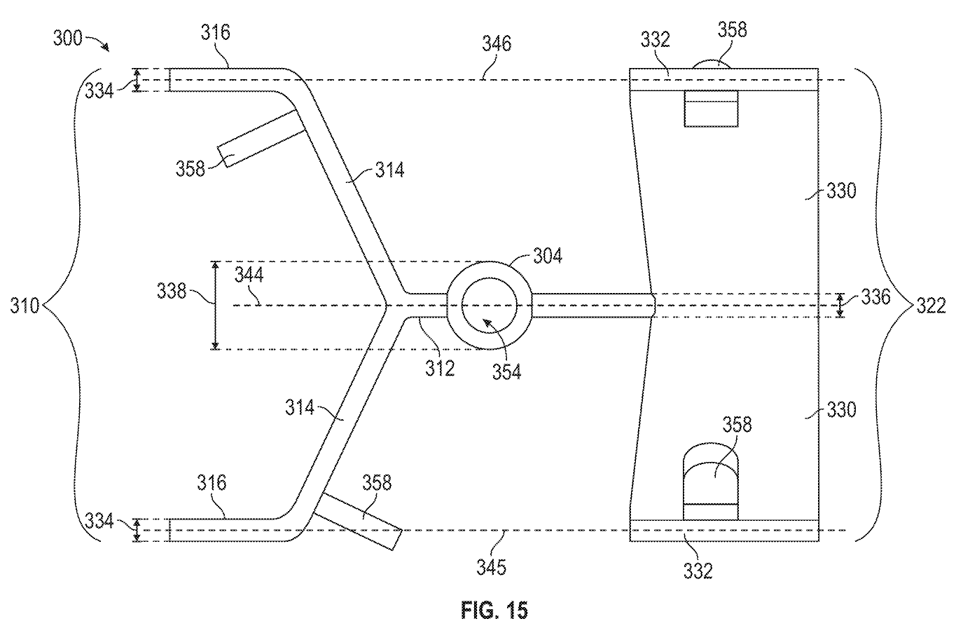

The various portions of the first segment 310 and the second segment 322 may be coupled together or formed from a single component, or a combination thereof. For example, the first segment 310 or the second segment 322 may be a single piece of material with a plurality of bends to orient the portions in a desired orientation. As shown in FIG. 15, among others, the first segment 310 and the second segment 322 may comprise a thin profile. For example, the first segment 310 and the second segment 322 may comprise a single sheet or layer of material. The first segment 310 may have a first segment width 334. The second segment 322 may have a second segment width 336. The first segment width 334 may be the same as or different than the second segment width 336. The mounting element 304 may have a mounting element width 338. The mounting element width 338 may be greater than both the first segment width 334 and the second segment width 336.

The second segment 322 is shown to include a second segment outer surface 340. The second segment outer surface 340 may extend along the second mounting portion 324, the extension portion 328, the second branch portions 330, and the second end portions 332. The second segment 322 is shown to include a second segment inner surface 342. The second segment inner surface 342 may extend along the second mounting portion 324, the extension portion 328, the second branch portions 330, and the second end portions 332. The outer mounting surface 306, the first segment outer surface 318, and a portion of the second segment outer surface 340 may form a planar outer surface. As shown in FIG. 15, among others the mounting element 304, the first mounting portion 312, the second mounting portion 324, and the extension portion 328 may be disposed in a first plane 344. A first end portion 316 and a second end portion 332 may share a plane. For example, one of the first end portions 316 and one of the second end portions 332 may be disposed in a second plane 345. Another of the first end portions 316 and another of the second end portions 332 may be disposed in a third plane 346. The second plane 345 and the third plane 346 may be offset from and parallel with the first plane 344.

In some embodiments, the first segment inner surface 320, the inner mounting surface 308, and the second segment inner surface 342 define a pocket 347. The pocket 347 is configured to receive at least a portion of a stud. The pocket 347 may allow for a larger stud to be used, which may improve the connection between the refractory anchor 300 and the thermal vessel. With the pocket 347, a mounting element depth 348 may be less than a first segment depth 350 (e.g., a maximum first segment depth 350) and less than a second segment depth 352 (e.g., a maximum second segment depth 352). The first segment depth 350 may be the same as or different than the second segment depth 352.

The mounting element 204 includes a recess 354. The recess 354 is configured to receive a first portion of a stud. The stud is configured to couple the refractory anchor 300 with the thermal vessel. The inner mounting surface 308 may be configured to interface with a second portion of the stud (e.g., a shoulder of the stud). At least a portion of the stud may be disposed in the pocket 347. In some embodiments, the mounting element 304 may be integrally formed with the stud.

The refractory anchor 300 is shown to include at least one opening or aperture, shown as void 356. The void 356 may extend through a portion of the main body 302. The void 356 may be configured to allow refractory to flow through the main body 302 when the refractory anchor 300 is mounted to the thermal vessel and the refractory is being installed. The main body 302 is shown to include a plurality of voids 356. For example, the main body 302 is shown to include a first void 356, a second void 356, and a third void 356. The first void 356 may extend between a first branch portion 314 and a first end portion 316. The second void 356 may be disposed on the second mounting portion 324. The third void 356 may extend between a second branch portion 330 and a second end portion 332.

The main body 302 is shown to include at least one reinforcement segment, shown as tab 358. The tab 358 may correspond with a void 356. In some embodiments, the tabs 358 may be linear and extend away from the main body 302. The tabs 358 may provide additional contact surface area for engaging and securing the refractory in place. The tabs 358 may protrude from the main body 302 to reduce unobstructed distances within the refractory, thereby better securing the refractory in the cells and helping reduce the likely incidence of biscuiting of the refractory. In some embodiments, the tabs 358 extend perpendicular to the corresponding segment. In some embodiments, the refractory anchor 300 has no tabs 358, or a subset of the voids 356 have tabs 358.

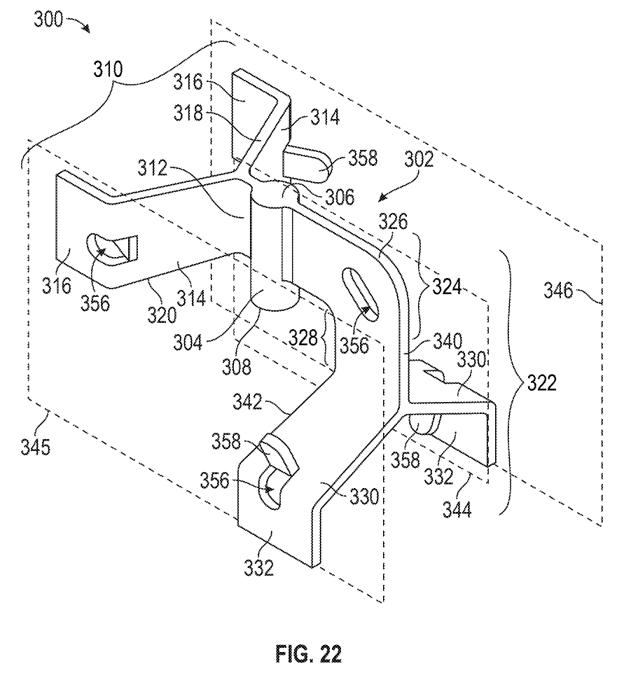

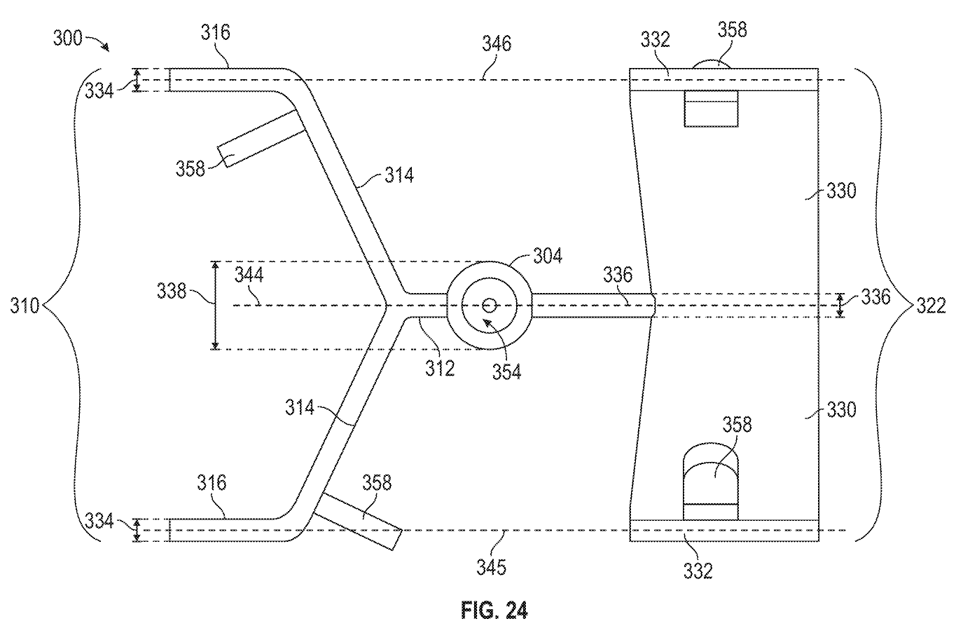

Referring now to FIGS. 22-24, in some embodiments the recess 354 and the pocket 347 are omitted and the mounting element 304 may define a longer length or height (e.g., the mounting element depth 348 of FIGS. 22-24 is greater than the mounting element depth 348 of FIGS. 11-15). For example, the mounting element depth 348 may be greater than the first segment depth 350 and greater than the second segment depth 352. In this embodiment, the inner mounting surface 308 of the mounting element 304 is configured to couple to the mounting surface of the thermal vessel. That is, rather than using a separate stud that is coupled to the mounting element 304 and then welded to the thermal vessel, the mounting element 304 is welded directly to the thermal vessel.

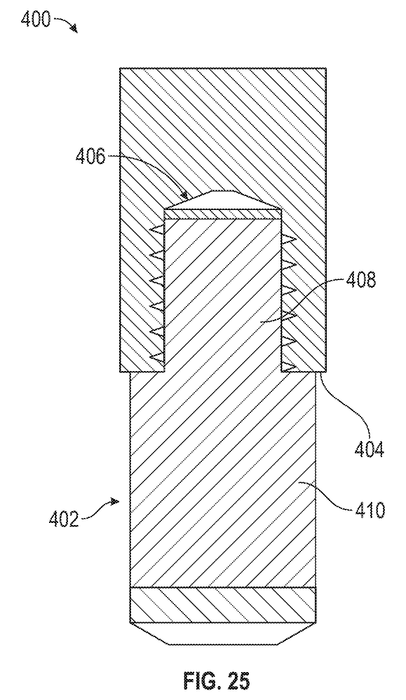

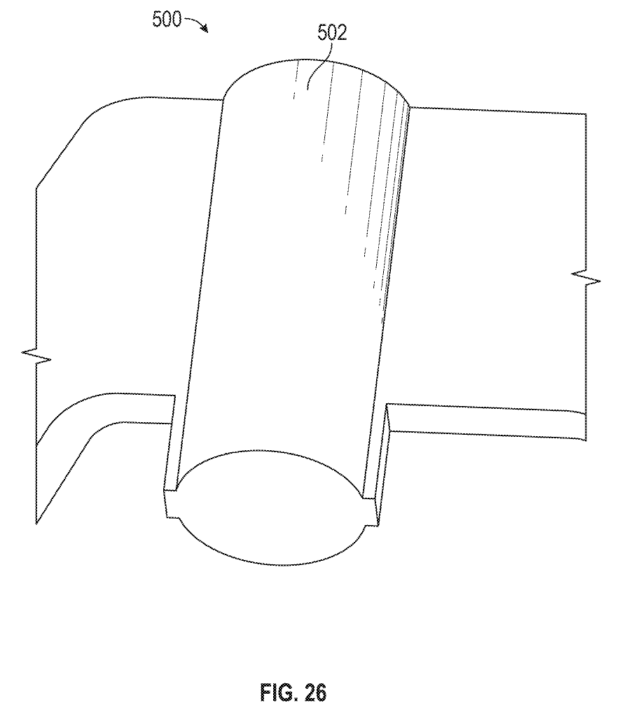

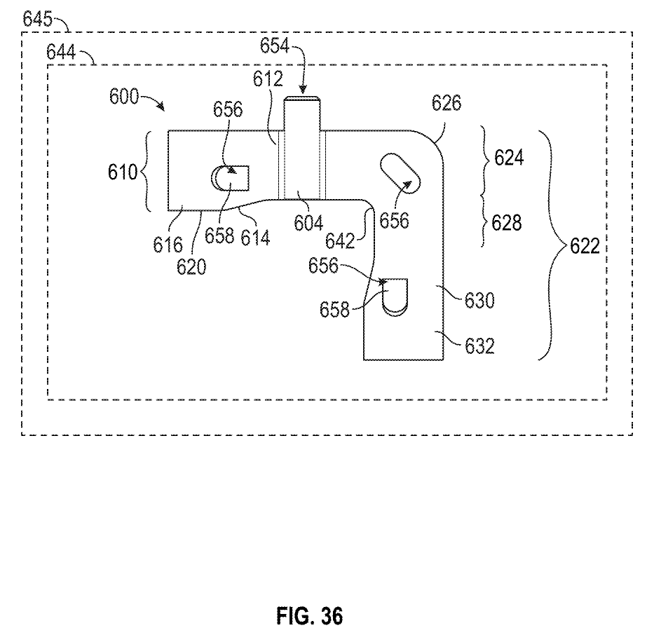

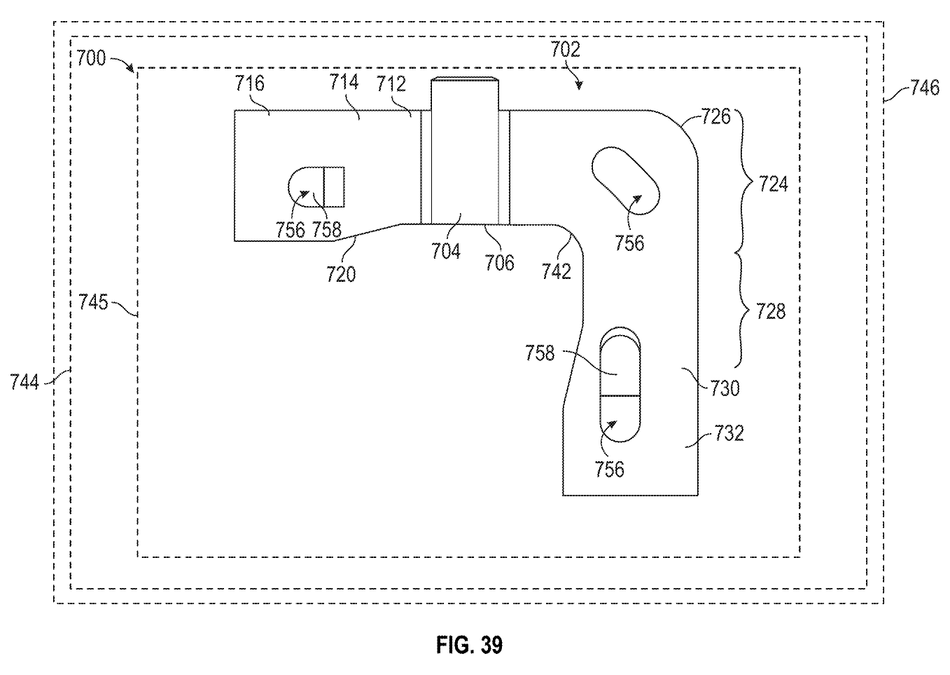

Referring to FIG. 25, a mounting element 400 is shown, according to an example embodiment. Mounting elements 104, 204, 304, 504, 604, 704 may be or include mounting element 400. In some embodiments, such as FIGS. 1-15, and 32-39, the mounting element 400 is the mounting element 104, the mounting element 204, the mounting element 304, the mounting element 504, the mounting element 604, or the mounting element 704 and the stud 402 is configured to be coupled within the mounting element 400. For example, the mounting element 400 may have an inner mounting surface 404 and include or define a recess 406. The stud 402 may have a first portion 408 and a second portion 410. The first portion 408 may be configured to be disposed in the recess 406. The second portion 410 may be configured to interface with the inner mounting surface 404. The stud 402 is configured to be coupled with the mounting surface of the thermal vessel, and the mounting element 400 is configured to couple with the stud 402. The stud 402 may be created from a different material than the main body 102, 202, 302, 502, 602, 702 of the refractory anchor 100, 200, 300 (e.g., to avoid the formation of brittle chromium carbine, etc.).

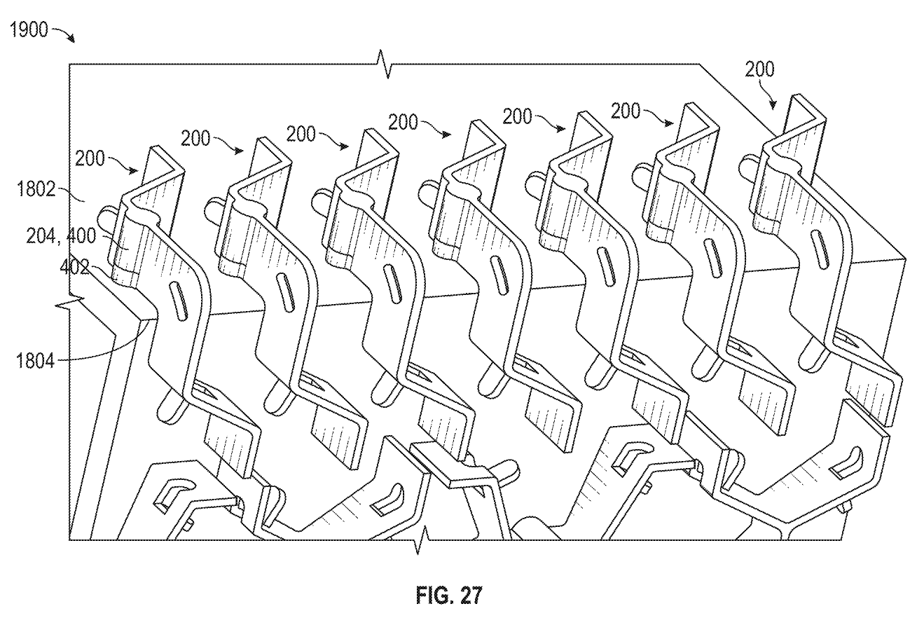

Referring to FIG. 26, a mounting element 500 is shown, according to an example embodiment. Mounting elements 104, 204, 304 may be or include mounting element 500. In some embodiments, such as in FIGS. 16-26, the mounting element 500 is the mounting element 104, the mounting element 204, or the mounting element 304, and is integrally formed (e.g., monolithic, unitary, etc.) with the main body 102, 202, 302, respectively (e.g., cast as a single body, etc.). For example, instead of comprising a recess 406 to couple with a stud 402, the mounting element 500 may comprise a single body 502 configured to couple a refractory anchor 100, 200, 300 with a thermal vessel.

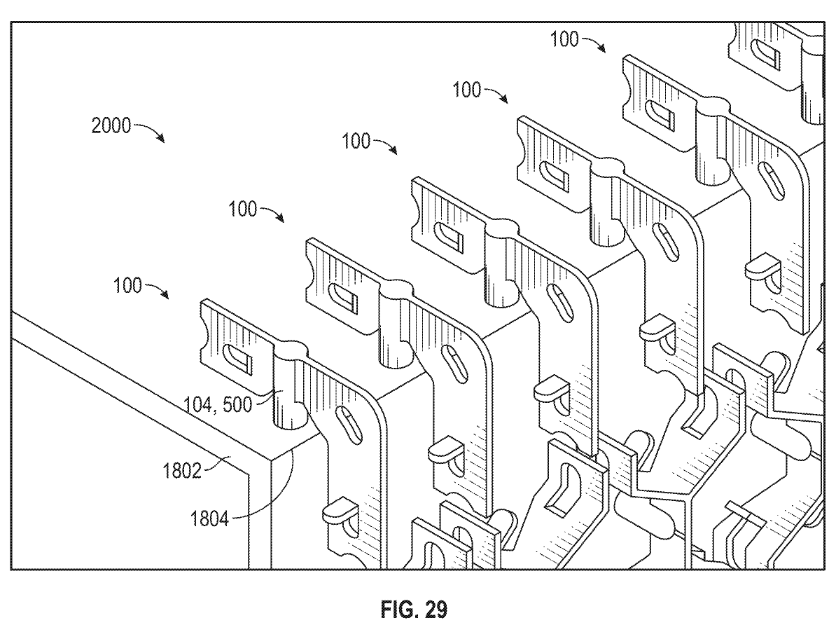

Referring to FIGS. 27-31, a plurality of refractory anchor arrays are shown, according to example embodiments. A plurality of refractory anchors 100, 200, 300 can be applied or installed for a single thermal vessel to create a refractory anchor array. For example, as shown in FIG. 29, a refractory anchor array 2000 is shown to include a plurality of refractory anchors 100 configured to couple with the thermal vessel 1802. The orientation of the components of the refractory anchor 100 allows the refractory anchor 100 to extend at least partially over an edge 1804 of the thermal vessel 1802. As such, other refractory anchors do not need to be specially made, cut, or modified to accommodate an edge 1804 of a thermal vessel 1802. The refractory anchors 100 forms a gap between the thermal vessel 1802 and the main body 102. The gap is configured to allow refractory to flow between the main body 102 and the thermal vessel 1802. The mounting element 104, 500 is configured to couple to the thermal vessel 1802.

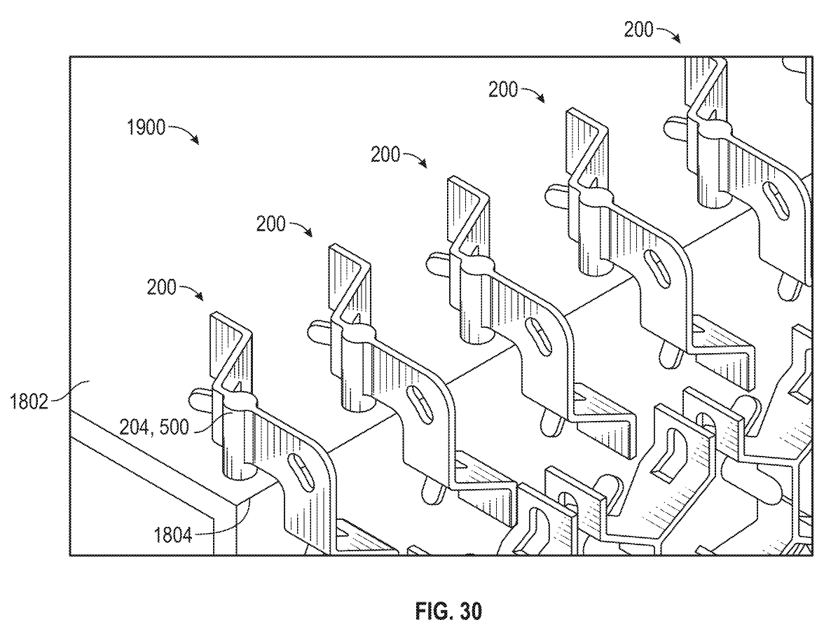

As shown in FIGS. 27 and 30, a refractory anchor array 1900 is shown to include a plurality of refractory anchors 200 configured to couple with the thermal vessel 1802. The orientation of the components of the refractory anchor 200 allows the refractory anchor 200 to extend at least partially over an edge 1804 of the thermal vessel 1802. As such, other refractory anchors do not need to be specially made, cut, or modified to accommodate an edge 1804 of a thermal vessel 1802. The second branch portion 230 and the first branch portion 214 may prevent the propagation of cracks in the refractory material (e.g., the crack would extend between the first branch portion 214 and the second branch portion 230 instead of extending to another refractory anchor). The refractory anchors 200 forms a gap between the thermal vessel 1802 and the main body 202. The gap is configured to allow refractory to flow between the main body 202 and the thermal vessel 1802. In FIG. 27, the stud 402 is configured to couple with the thermal vessel 1802, and the mounting element 400 is configured to couple the refractory anchor 200 with the stud 402. In FIG. 30, the mounting element 204, 500 is configured to couple the refractory anchor 200 to the thermal vessel 1802.

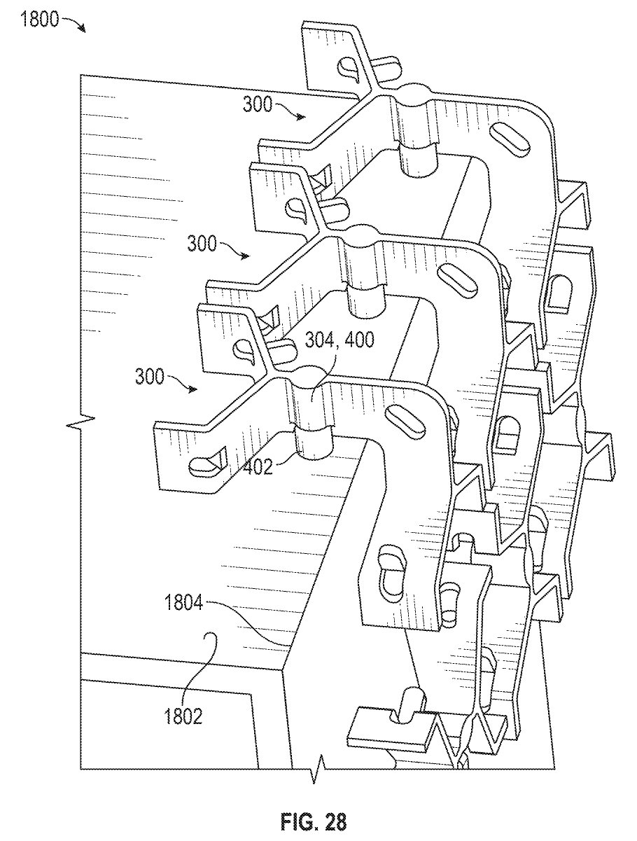

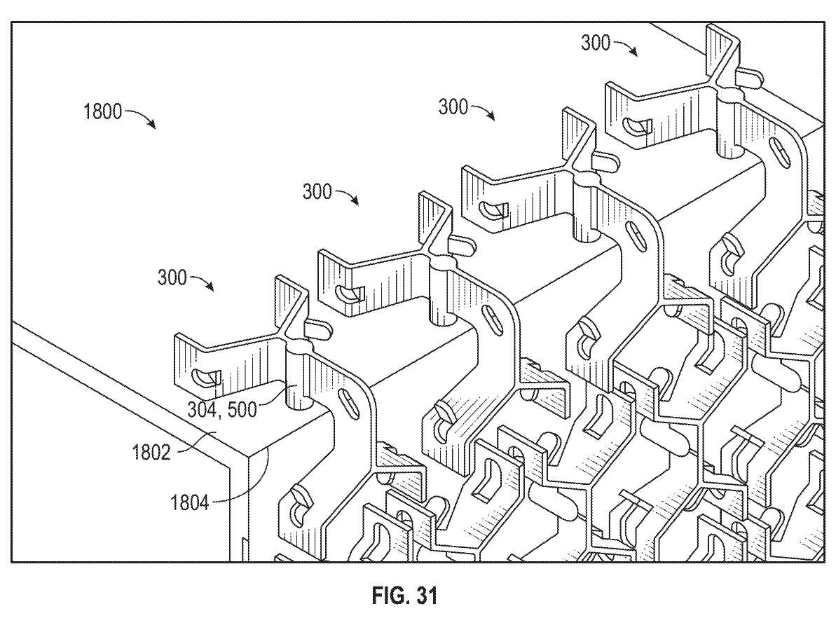

As shown in FIGS. 28 and 31, a refractory anchor array 1800 is shown to include a plurality of refractory anchors 300 configured to couple with a thermal vessel 1802. The orientation of the components of the refractory anchor 300 allows the refractory anchor 300 to extend at least partially over an edge 1804 of the thermal vessel 1802. As such, other refractory anchors do not need to be specially made, cut, or modified to accommodate an edge 1804 of a thermal vessel 1802. The first branch portion 314 and the second branch portion 330 may further prevent the propagation of cracks in the refractory material (e.g., the crack would extend between the first branch portion 314 and the second branch portion 330 instead of extending to another refractory anchor). The refractory anchors 300 forms a gap between the thermal vessel 1802 and the main body 302. The gap is configured to allow refractory to flow between the main body 302 and the thermal vessel 1802. In FIG. 28, the stud 402 is configured to couple with the thermal vessel 1802, and the mounting element 400 is configured to couple the refractory anchor 300 with the stud 402. In FIG. 31, the mounting element 304, 500 is configured to couple the refractory anchor 300 with the thermal vessel 1802.

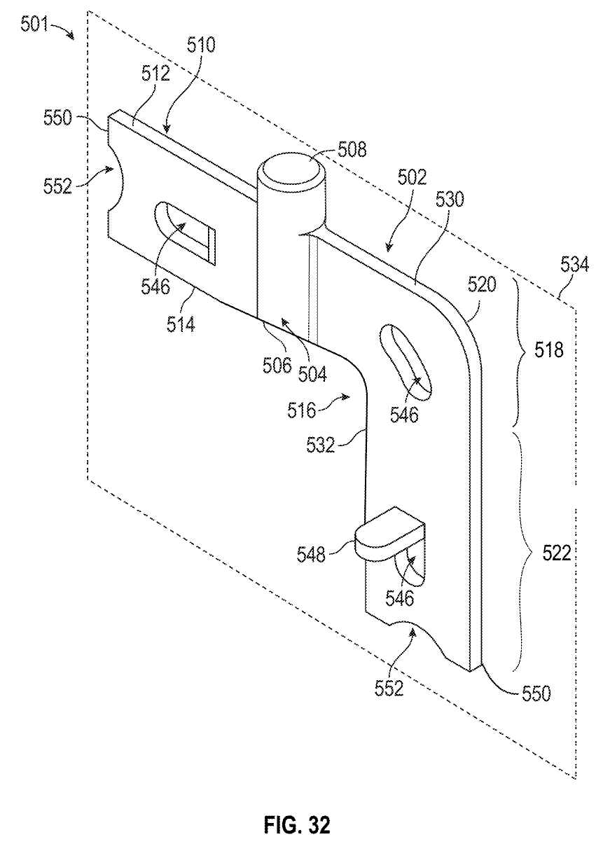

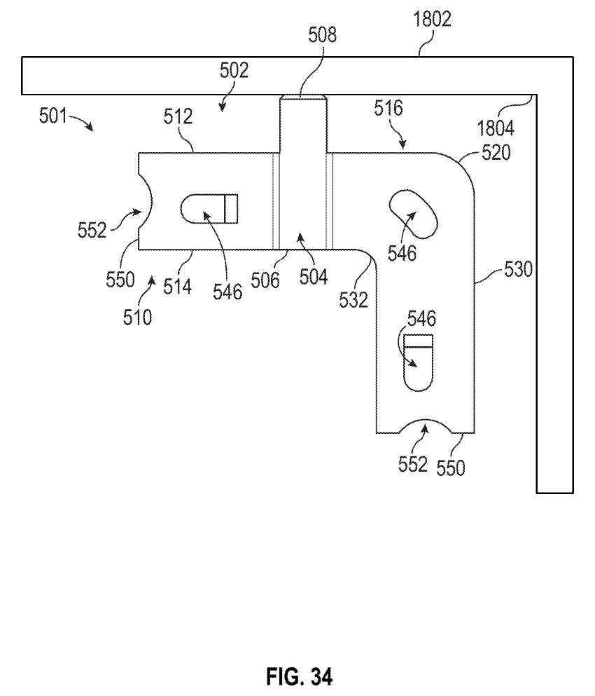

Referring now FIGS. 32-34, an example refractory anchor 501 is shown, according to an example embodiment. The refractory anchor 501 includes a main body 502. The main body 502 is configured to extend at least partially around an edge of a thermal vessel 1802. The main body 502 is shown to include an L-shape arrangement end-to-end. For example, the main body 502 may have a first portion extending in a first direction and a second portion extending from an end of the first portion at approximately a right angle to create an L-shape. The main body 502 includes a mounting element 504. The mounting element 504 may be configured to couple the refractory anchor 501 with the thermal vessel 1802. Specifically, as shown in FIG. 34 the mounting element 504 is shown to be configured to couple the refractory anchor 501 to an interior mounting surface of the thermal vessel 1802. The mounting element 504 is shown to include a first surface, shown as inner surface 506, and a second surface, shown as outer mounting surface 508. The outer mounting surface 508 is opposite the inner surface 506. The outer mounting surface 508 is configured to confront or engage a mounting surface of the thermal vessel 1802. The refractory anchor 501 may be substantially similar to the refractory anchor 100, except that the mounting element 504, the inner surface 506 and the outer mounting surface 508 are positioned opposite the mounting element 104, the inner mounting surface 108, and the outer mounting surface 106 relative to the main body 102, 502 (e.g., the mounting element 504 is flipped 180 degrees relative to the mounting element 104).

The main body 502 includes a first segment 510. The first segment 510 may extend from the mounting element 504 in a first direction. The first segment 510 is a straight (e.g., linear) segment extending away from the mounting element 504. The first segment 510 may be coupled with or integrally formed with the mounting element 504. The first segment 510 may be the same material as or a different material than the mounting element. The first segment 510 includes a first segment outer surface 512 and a first segment inner surface 514. The first segment outer surface 512 is opposite the first segment inner surface 514. The first segment outer surface 512 is configured to confront the mounting surface of the thermal vessel 1802.

The main body 502 includes a second segment 516. The second segment 516 extends from the mounting element 504. The second segment 516 may be coupled with or integrally formed with the mounting element 504. The second segment 516 may be the same material as or a different material than the mounting element. The second segment 516 is shown to include a mounting portion 518. The mounting portion 518 may extend from the mounting element 504 in a second direction. The second direction may be opposite the first direction of the first segment 510. The mounting portion 518 is shown to include a bend 520. The second segment 516 is shown to include an extension portion 522. The extension portion 522 may extend from the mounting portion 518 in a third direction. The third direction may be the different from the second direction. For example, the third direction may be perpendicular to the second direction.

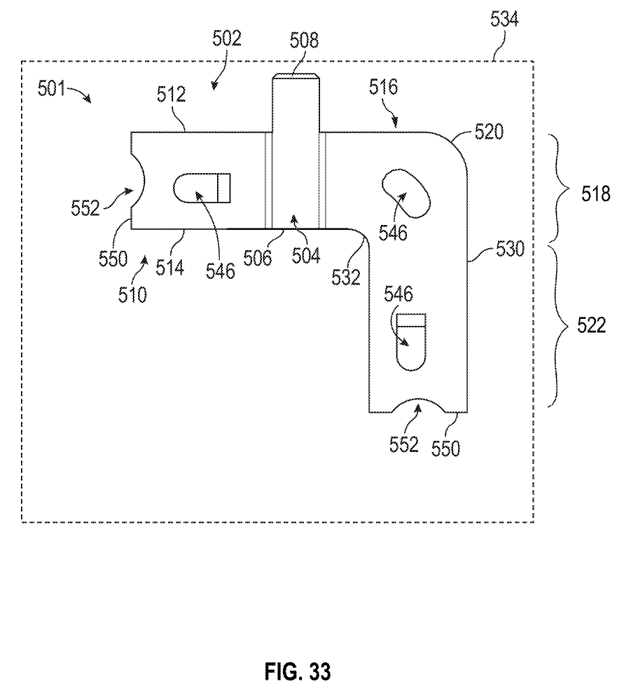

The second segment 516 is shown to include a second segment outer surface 530 and a second segment inner surface 532. The second segment outer surface 530 may extend along the mounting portion 518 and the extension portion 522. The second segment inner surface 532 may extend along the inner surface 506 and the extension portion 522. The second segment outer surface 530 may extend along the mounting portion 518 and the extension portion 522. TAs shown in FIGS. 32-33, among others, the first segment 510, the mounting element 504, and the second segment 516 may be disposed in a plane 534.

The first segment inner surface 514, the inner surface 506, and a section of the second segment inner surface 532 may form a planar inner surface. For example, as shown in FIGS. 32-34, the first segment inner surface 514, the second segment inner surface 532, and the inner surface 506 are coplanar along at least a portion of their lengths. In this way, at least a portion of the first segment inner surface 514, at least a portion of the second segment inner surface 532 and the inner surface 506 form a continuous flat surface. The mounting element 504 is shown to extend outward relative to the first segment outer surface 512 and the second segment outer surface 530. In this way, the outer mounting surface 508 of the mounting element 504 is raised relative to the first segment outer surface 512 and the second segment outer surface 530.

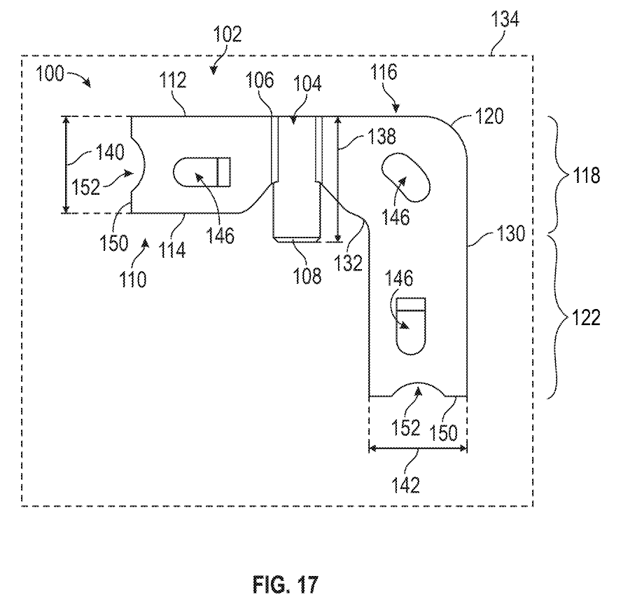

The refractory anchor 501 is shown to include at least one opening or aperture, shown as void 546. The void 546 may be the same or substantially similar to the void 146 shown in FIGS. 16 and 17. The void 546 may extend through a portion of the main body 502. The void 546 may be configured to allow refractory to flow through the main body 502 when the refractory anchor 501 is mounted to the thermal vessel 1802. The main body 502 is shown to include a plurality of voids 546. For example, the first segment 510 is shown to include a first void 546. The second segment 516 is shown to include a second void 546 and a third void 546. The second void 546 may be disposed on the mounting portion 518. The third void 546 may be disposed on the extension portion 522.

The main body 502 is shown to include at least one reinforcement segment, shown as tab 548. The tab 548 may correspond with a void 546. The tab 548 may be the same or substantially similar to the tab 148 shown in FIGS. 16 and 17. In some embodiments, the tabs 548 may be linear and extend away from the main body 502. The tabs 548 may provide additional contact surface area for engaging and securing the refractory in place. The tabs 548 may protrude from the main body 502 to reduce unobstructed distances within the refractory, thereby better securing the refractory in the cells and helping reduce the likely incidence of biscuiting of the refractory. In some embodiments, the tabs 548 extend at an acute angle, at an obtuse angle, or perpendicular to the corresponding segment. In some embodiments, the refractory anchor 501 has no tabs 548, or a subset of the voids 546 have tabs 548.

In some embodiments, the main body 502 may have at least one segment end 550. The segment end 550 may be disposed at an end of the first segment 510 or the second segment 516. The segment end 550 is shown to include at least one indented region 552. The indented region 552 may have a curved surface. The indented region 552 may be the same or substantially similar to the indented region 152 shown in FIGS. 16-17.

In this embodiment, the outer mounting surface 508 of the mounting element 504 is configured to couple to an interior mounting surface of the thermal vessel 1802. That is, rather than using a separate stud that is coupled to the mounting element 504 and then welded to the thermal vessel 1802, the mounting element 504 is welded directly to the interior mounting surface of the thermal vessel 1802.

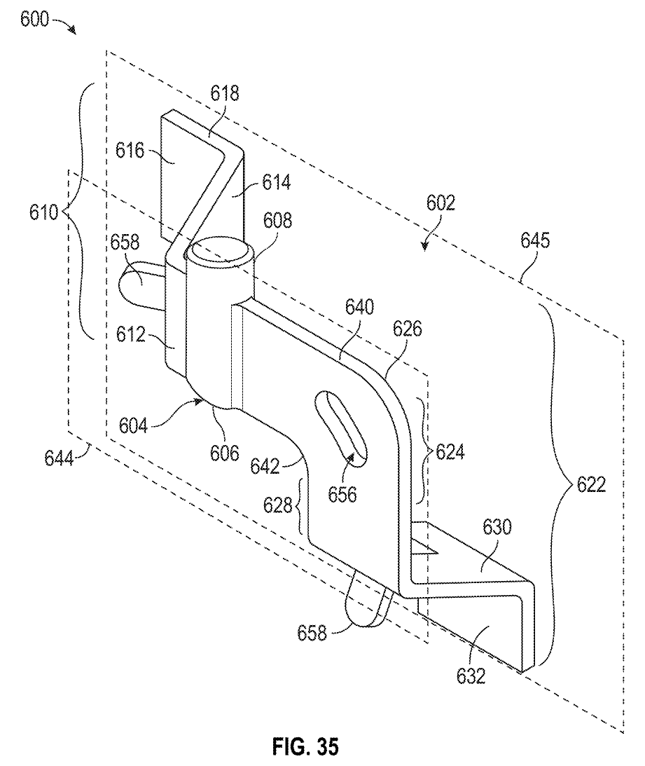

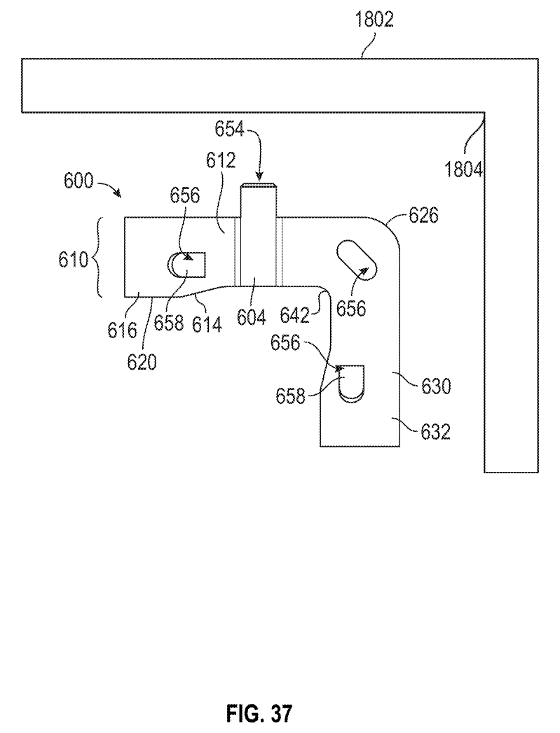

Referring to FIGS. 35-37, an example refractory anchor 600 is shown, according to an example embodiment. The refractory anchor 600 includes a main body 602. The main body 602 is configured to extend at least partially around an interior edge 1804 of a thermal vessel 1802. The main body 602 includes a mounting element 604. The mounting element 604 may be configured to couple the refractory anchor 600 with the thermal vessel 1802. Specifically, as shown in FIG. 37 the mounting element 604 is shown to be configured to couple the refractory anchor 600 to an interior mounting surface of the thermal vessel 1802. The mounting element 604 is shown to include a first surface, shown as inner surface 606, and a second surface, shown as outer mounting surface 608. The inner surface 606 is opposite the outer mounting surface 608. The outer mounting surface 608 is configured to confront the mounting surface of the thermal vessel. The refractory anchor 600 may be substantially similar to the refractory anchor 200, except that the mounting element 604, the inner surface 606 and the outer mounting surface 608 are positioned opposite the mounting element 204, the inner mounting surface 208, and the outer mounting surface 206 relative to the main body 202, 602 (e.g., the mounting element 604 is flipped 180 degrees relative to the mounting element 204).

The main body 602 includes a first segment 610. The first segment 610 may extend from the mounting element 604. The first segment 610 is a non-linear (e.g., bent, curvy, etc.) segment extending away from the mounting element 604. The first segment 610 may be coupled with or integrally formed with the mounting element 604. The first segment 610 may be the same material as or a different material than the mounting element 604.

The first segment 610 is shown to include a first mounting portion 212. The first mounting portion 212 may extend in a first direction from the mounting element 604. The first segment 610 is shown to include a first branch portion 214. The first branch portion 214 may extend from the first mounting portion 212 at an obtuse angle relative to the first mounting portion 612. The first segment 610 is shown to include a first end portion 616. The first end portion 616 may extend from the first branch portion 614 parallel with the first mounting portion 612. The first segment 610 is shown to include a first segment outer surface 618 and a first segment inner surface 620. The first segment outer surface 618 is opposite the first segment inner surface 620. The first segment outer surface 618 is configured to confront the mounting surface of the thermal vessel. The first segment outer surface 618 may extend along the first mounting portion 612, the first branch portion 614, and the first end portion 616. The first segment inner surface 620 may extend along the first mounting portion 612, the first branch portion 214, and the first end portion 616.

The main body 602 includes a second segment 622. The second segment 622 extends from the mounting element 604. The second segment 622 may be coupled with or integrally formed with the mounting element 604. The second segment 622 may be the same material as or a different material than the mounting element 604. The second segment 622 is shown to include a second mounting portion 624. The second mounting portion 624 may extend in a second direction from the mounting element 604. The second direction may be opposite the first direction of the first mounting portion 612. The second mounting portion 624 is shown to include a bend 626. The second segment 622 is shown to include an extension portion 628. The extension portion 628 may extend from the second mounting portion 624 in a third direction. The third direction may be different than the second direction. For example, the third direction may be perpendicular to the second direction. The second segment 622 is shown to include a second branch portion 630. The second branch portion 630 may extend from the extension portion 628 at an obtuse angle relative to the extension portion 628. The second segment 622 is shown to include a second end portion 632. The second end portion 632 may extend from the second branch portion 630 parallel with the extension portion 628.

The various portions of the first segment 610 and the second segment 622 may be coupled together or formed from a single component, or a combination thereof. For example, the first segment 610 or the second segment 622 may be a single piece of material with a plurality of bends to orient the portions in a desired orientation. The first segment 610 and the second segment 622 may comprise a thin profile. For example, the first segment 610 and the second segment 622 may comprise a single sheet or layer of material.

The second segment 622 is shown to include a second segment outer surface 640. The second segment outer surface 640 may extend along the second mounting portion 624, the extension portion 628, the second branch portion 630, and the second end portion 632. The second segment 622 is shown to include a second segment inner surface 642. The second segment inner surface 642 may extend along the second mounting portion 624, the extension portion 628, the second branch portion 630, and the second end portion 632. As shown in FIG. 35, among others, the mounting element 604, the first mounting portion 612, the second mounting portion 624, and the extension portion 628 may be disposed in a first plane 644. As shown in FIG. 35, the first end portion 616 and the second end portion 632 may be disposed in a second plane 645. The second plane 645 may be offset from and parallel with the first plane 644.

The first segment inner surface 620, the inner surface 606, and a section of the second segment inner surface 642 may form a planar inner surface. For example, as shown in FIGS. 35-37, the first segment inner surface 620, the second segment inner surface 642, and the inner surface 606 are coplanar along at least a portion of their lengths. In this way, at least a portion of the first segment inner surface 620, at least a portion of the second segment inner surface 642 and the inner surface 606 form a continuous flat surface. The mounting element 604 is shown to extend outward relative to the first segment outer surface 618 and the second segment outer surface 640. In this way, the outer mounting surface 608 of the mounting element 604 is raised relative to the first segment outer surface 618 and the second segment outer surface 640.

The mounting element 604 is shown to include a recess 654. The recess 654 may be configured to receive a first portion of a stud (e.g., the stud 402). The stud may be configured to couple the refractory anchor 600 with the thermal vessel. The outer mounting surface 608 may be configured to interface with a second portion of the stud (e.g., a shoulder of the stud). In some embodiments, the mounting element 604 may be integrally formed (e.g., monolithic, unitary, etc.) with the stud. For example, instead of comprising a recess 654 to couple with a stud 402, the mounting element 604 may comprise a single body configured to couple a refractory anchor 600 with a thermal vessel. Similarly, the mounting elements 504 and 704 may include a recess configured to receive the stud 402. Alternatively, the mounting elements 504 and 704 be integrally formed with the stud, such that the mounting elements 504 and 704 form a single body to couple the refractory anchor 501, 700 with the thermal vessel.

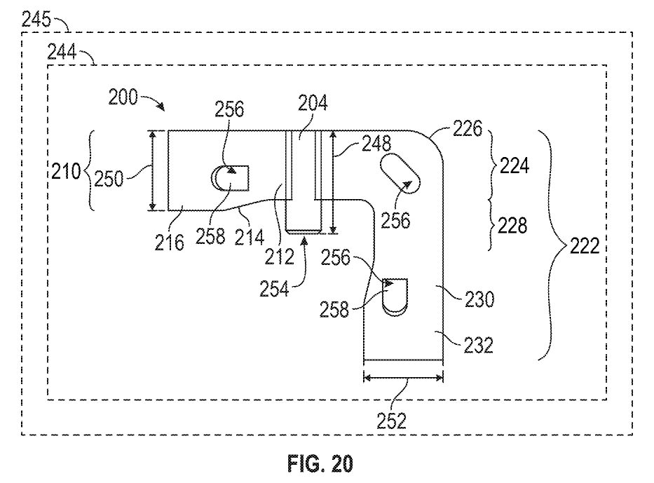

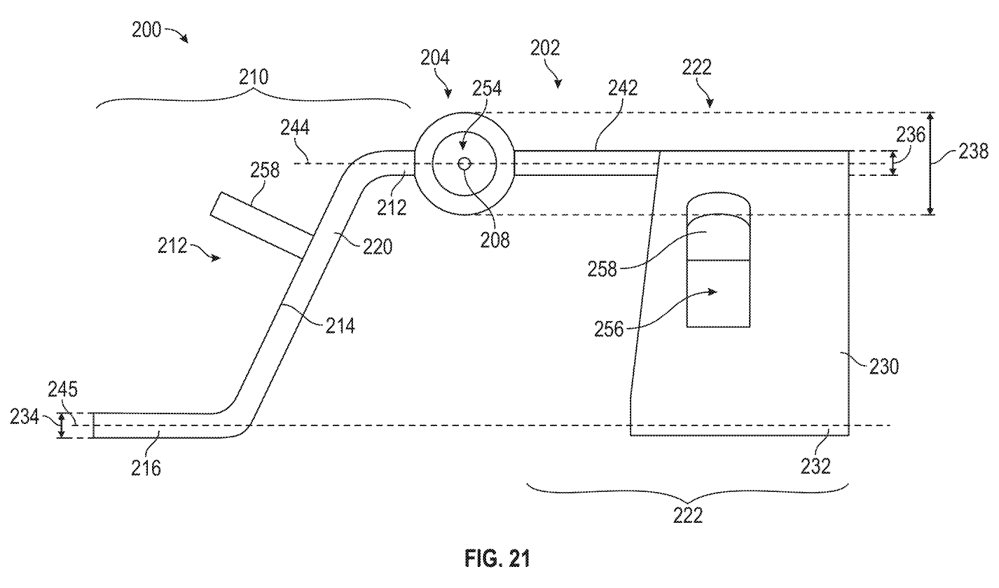

The refractory anchor 600 is shown to include at least one opening or aperture, shown as void 656. The void 656 may extend through a portion of the main body 602. The voids 656 may be the same or substantially similar to the voids 256 shown in FIGS. 19-20. The void 656 may be configured to allow refractory to flow through the main body 602 when the refractory anchor 600 is mounted to the thermal vessel and the refractory is being installed. The main body 602 is shown to include a plurality of voids 656. For example, the first segment 610 is shown to include a first void 656. The second segment 622 is shown to include a second void 656 and a third void 656. The second void 656 may be disposed on the second mounting portion 624. The third void 656 may be disposed on the second branch portion 630.

The main body 602 is shown to include at least one reinforcement segment, shown as tab 658. The tab 658 may correspond with a void 656. The tabs 658 may be the same or substantially similar to the tabs 258 shown in FIGS. 19-20. In some embodiments, the tabs 658 may be linear and extend away from the main body 602. The tabs 658 may provide additional contact surface area for engaging and securing the refractory in place. The tabs 658 may protrude from the main body 602 to reduce unobstructed distances within the refractory, thereby better securing the refractory in the cells and helping reduce the likely incidence of biscuiting of the refractory. In some embodiments, the tabs 658 extend perpendicular to the corresponding segment. In some embodiments, the refractory anchor 600 has no tabs 658, or a subset of the voids 656 have tabs 658.

In this embodiment, the outer mounting surface 608 of the mounting element 604 is configured to couple to the mounting surface of the thermal vessel. That is, rather than using a separate stud that is coupled to the mounting element 604 and then welded to the thermal vessel, the mounting element 604 is welded directly to the thermal vessel.

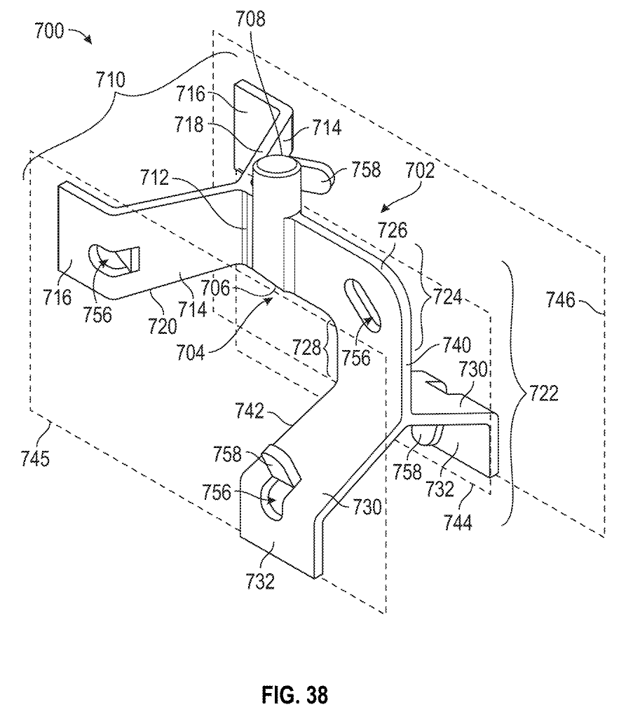

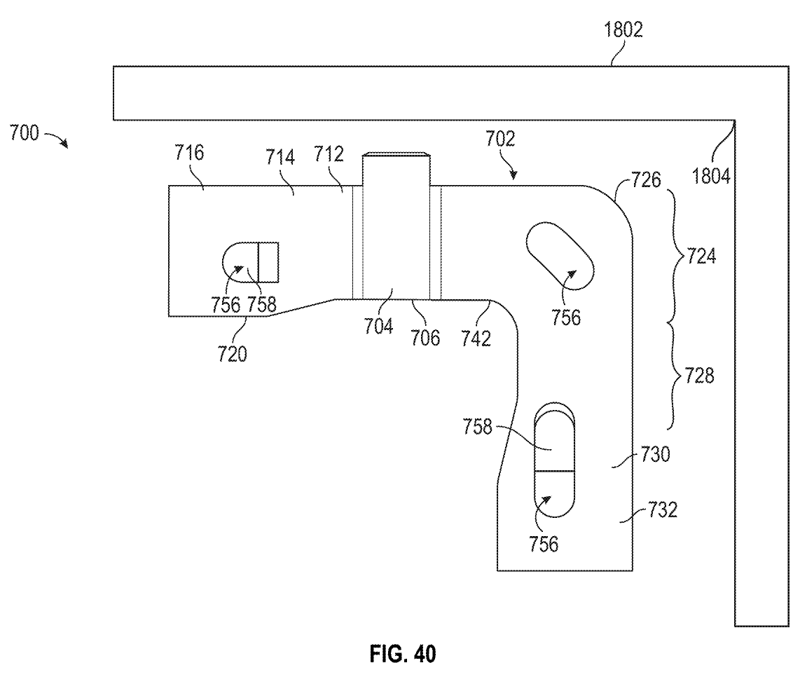

Referring to FIGS. 38-40, an example refractory anchor 700 is shown, according to an example embodiment. The refractory anchor 700 includes a main body 702. The main body 702 is configured to extend at least partially around an interior edge 1804 of a thermal vessel 1802. The main body 702 includes a mounting element 704. The mounting element 704 may be configured to couple the refractory anchor 700 with an interior surface of the thermal vessel 1802. The mounting element 704 is shown to include a first surface, shown as inner surface 706, and a second surface, shown as outer mounting surface 708. The inner surface 706 is opposite the outer mounting surface 708. The outer mounting surface 708 is configured to confront the mounting surface of the thermal vessel 1802. The refractory anchor 700 may be substantially similar to the refractory anchor 300, except that the mounting element 704, the inner surface 706 and the outer mounting surface 708 are positioned opposite the mounting element 304, the inner mounting surface 308, and the outer mounting surface 306 relative to the main body 302, 702 (e.g., the mounting element 704 is flipped 180 degrees relative to the mounting element 304).

The main body 702 includes a first segment 710. The first segment 710 may extend from the mounting element 704. The first segment 710 is a non-linear (e.g., bent, curvy, etc.) segment extending away from the mounting element 704. The first segment 710 may be coupled with or integrally formed with the mounting element 704. The first segment 710 may be the same material as or a different material than the mounting element 704.

The first segment 710 is shown to include a first mounting portion 712. The first mounting portion 712 may extend in a first direction from the mounting element 704. The first segment 710 is shown to include a plurality of first branch portions 714. The first branch portions 714 may extend from the first mounting portion 712 at an obtuse angle relative to the first mounting portion 712. For example, one of the first branch portions 714 may extend from the first mounting portion 712 in a first direction at the obtuse angle and another of the first branch portions 714 may extend from the first mounting portion 712 in a second direction at the obtuse angle. The first segment 710 is shown to include a plurality of first end portions 716. Each of the first end portions 716 may extend from a corresponding first branch portion 714. The first end portions 716 may extend parallel with the first mounting portion 712. The first segment 710 is shown to include a first segment outer surface 718 and a first segment inner surface 720. The first segment outer surface 718 is opposite the first segment inner surface 720. The first segment inner surface 720 is configured to confront the mounting surface of the thermal vessel. The first segment outer surface 718 may extend along the first mounting portion 712, the first branch portions 714, and the first end portions 716. The first segment inner surface 720 may extend along the first mounting portions 712, the first branch portions 714, and the first end portions 716.

The main body 702 includes a second segment 722. The second segment 722 extends from the mounting element 704. The second segment 722 may be coupled with or integrally formed with the mounting element 704. The second segment 722 may be the same material as or a different material than the mounting element 704. The second segment 722 is shown to include a second mounting portion 724. The second mounting portion 724 may extend in a second direction from the mounting element 704. The second direction may be opposite the first direction of the first mounting portion 712. The second mounting portion 724 is shown to include a bend 726. The second segment 722 is shown to include an extension portion 728. The extension portion 728 may extend from the second mounting portion 724 in a third direction. The third direction may be different than the second direction. For example, the third direction may be perpendicular to the second direction.

The second segment 722 is shown to include a plurality of second branch portions 730. The second branch portions 730 may extend from the extension portion 728 at an obtuse angle relative to the extension portion 728. For example, one of the second branch portions 730 may extend from the extension portion 728 in a first direction at the obtuse angle and another one of the second branch portions 730 may extend from the extension portion 728 in a second direction at the obtuse angle. The second segment 722 is shown to include a plurality of second end portions 732. Each of the second end portions 732 may extend from a corresponding second branch portion 730. The second end portions 732 may extend parallel with the extension portion 728.

The various portions of the first segment 710 and the second segment 722 may be coupled together or formed from a single component, or a combination thereof. For example, the first segment 710 or the second segment 722 may be a single piece of material with a plurality of bends to orient the portions in a desired orientation. The first segment 710 and the second segment 722 may comprise a thin profile. For example, the first segment 710 and the second segment 722 may comprise a single sheet or layer of material.

The second segment 722 is shown to include a second segment outer surface 740. The second segment outer surface 740 may extend along the second mounting portion 724, the extension portion 728, the second branch portions 730, and the second end portions 732. The second segment 722 is shown to include a second segment inner surface 742. The second segment inner surface 742 may extend along the second mounting portion 724, the extension portion 728, the second branch portions 730, and the second end portions 732. As shown in FIG. 38, among others the mounting element 704, the first mounting portion 712, the second mounting portion 724, and the extension portion 728 may be disposed in a first plane 744. A first end portion 716 and a second end portion 732 may share a plane. For example, one of the first end portions 716 and one of the second end portions 732 may be disposed in a first plane 744. Another of the first end portions 716 and another of the second end portions 732 may be disposed in a third plane 746. The second plane 745 and the third plane 746 may be offset from and parallel with the first plane 744.

The first segment inner surface 720, the mounting element 704, and a section of the second segment inner surface 742 may form a planar inner surface. For examples, as shown in FIGS. 38-40, the first segment inner surface 720, the second segment inner surface 742, and the inner surface 706 are coplanar along at least a portion of their lengths. In this way, at least a portion of the first segment inner surface 720, at least a portion of the second segment inner surface 742 and the inner surface 706 form a continuous flat surface. The mounting element 704 is shown to extend outward relative to the first segment outer surface 718 and the second segment outer surface 740. In this way, the outer mounting surface 708 of the mounting element 704 is raised relative to the first segment outer surface 718 and the second segment outer surface 740.

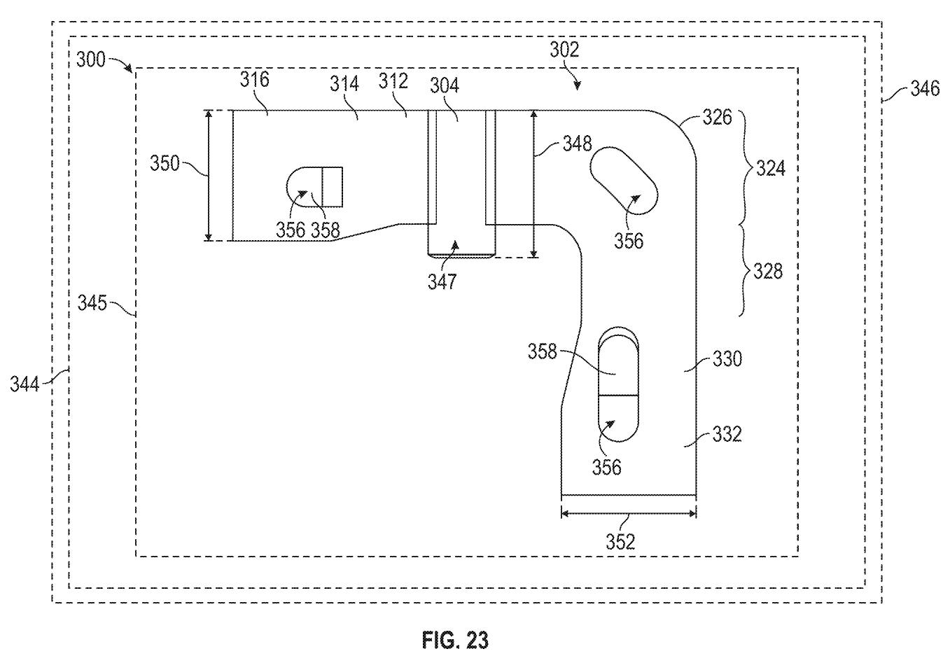

The refractory anchor 700 is shown to include at least one opening or aperture, shown as void 756. The void 756 may extend through a portion of the main body 702. The void 756 may be the same or substantially similar to the void 356 shown in FIGS. 22-23. The void 756 may be configured to allow refractory to flow through the main body 702 when the refractory anchor 700 is mounted to an interior side of the thermal vessel 1802 and the refractory is being installed. The main body 702 is shown to include a plurality of voids 756. For example, the main body 702 is shown to include a first void 756, a second void 756, and a third void 756. The first void 756 may extend between a first branch portion 714 and a first end portion 716. The second void 756 may be disposed on the second mounting portion 724. The third void 756 may extend between a second branch portion 730 and a second end portion 732.

The main body 702 is shown to include at least one reinforcement segment, shown as tab 758. The tabs 758 may be the same or substantially similar to the tabs 358 shown in FIGS. 22-23. The tab 758 may correspond with a void 756. In some embodiments, the tabs 758 may be linear and extend away from the main body 702. The tabs 758 may provide additional contact surface area for engaging and securing the refractory in place. The tabs 758 may protrude from the main body 702 to reduce unobstructed distances within the refractory, thereby better securing the refractory in the cells and helping reduce the likely incidence of biscuiting of the refractory. In some embodiments, the tabs 758 extend perpendicular to the corresponding segment. In some embodiments, the refractory anchor 700 has no tabs 758, or a subset of the voids 756 have tabs 758.

In this embodiment, the outer mounting surface 708 of the mounting element 704 is configured to couple to the internal mounting surface of the thermal vessel 1802. That is, rather than using a separate stud that is coupled to the mounting element 704 and then welded to the thermal vessel 1802, the mounting element 704 is welded directly to the thermal vessel 1802.

The refractory anchors 501, 600, and 700 may be coupled to other refractory anchors 501, 600, 700 to create a refractory anchor array that extends across the inner surfaces of the thermal vessel 1802. Advantageously, the refractory anchors 501, 600, 700 may extend at least partially around an interior edge 1804 of the thermal vessel 1802, as shown in FIG. 34. The mounting elements 504, 604, and 704 are configured to couple the refractory anchors 501, 600, 700 to the interior of the thermal vessel 1802. The orientation of the components of the refractory anchors 501, 600, 700 allows the refractory anchors 501, 600, 700 to extend at least partially over an edge 1804 of the thermal vessel 1802. As such, other refractory anchors do not need to be specially made, cut, or modified to accommodate an interior edge 1804 of a thermal vessel 1802. The refractory anchors 501, 600, 700 forms a gap between the interior mounting surface of the thermal vessel 1802 and the main bodies 502, 602, 702. The gap is configured to allow refractory to flow between the main bodies 502, 602, 702 of the refractory anchors 501, 600, 700 and the interior mounting surface of the thermal vessel 1802. The mounting elements 504, 604, 704 are configured to couple to the interior mounting surface of the thermal vessel 1802.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element is shown to include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive “or” to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, or orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of top and bottom, upper and lower, front and back, or left and right may be reversed or interchangeable. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An anchoring device for a refractory material for lining a thermal vessel, the anchoring device comprising:
a main body having an L-shape configured to extend at least partially around an interior edge of the thermal vessel, the main body comprising:
a mounting element including an inner surface and an outer mounting surface;
a first segment extending from the mounting element in a first direction, the first segment comprising a first segment outer surface and a first segment inner surface; and
a second segment extending from the mounting element, the second segment comprising:
a mounting portion extending in a second direction from the mounting element, the second direction opposite the first direction;
an extension portion extending from the mounting portion in a third direction, the third direction different from the second direction;
a second segment outer surface extending along the mounting portion and the extension portion; and
a second segment inner surface extending along the inner surface of the mounting element and the extension portion;
wherein the inner surface, the first segment inner surface, and a section of the second segment inner surface form a planar inner surface; and
wherein the mounting element, the first segment, and the second segment are disposed in a plane.

2. The anchoring device of claim 1, wherein the third direction is perpendicular to the second direction.

3. The anchoring device of claim 1, wherein the mounting element is integrally formed with a stud, the stud extending from the outer mounting surface and configured to couple the anchoring device with an interior surface of the thermal vessel.

4. The anchoring device of claim 1, wherein the main body further comprises a plurality of voids, wherein the first segment comprises a first void of the plurality of voids and the second segment comprises a second void and a third void of the plurality of voids, the second void disposed on the mounting portion, and the third void disposed on the extension portion.

5. The anchoring device of claim 4, wherein the main body further comprises a one or more tabs extending away from the main body, wherein the one or more tabs correspond to at least one of the plurality of voids.

6. The anchoring device of claim 1, wherein the outer mounting surface of the mounting element is positioned on a same side as the first segment outer surface and the second segment outer surface, such that the mounting element extends outward relative to the first segment outer surface and the second segment outer surface.

7. The anchoring device of claim 1, wherein the mounting element comprises a recess configured to receive a first portion of a stud, and the outer mounting surface of the mounting element is configured to interface with a second portion of the stud.

8. An anchoring device for a refractory material for lining a thermal vessel, the anchoring device comprising:
a main body configured to extend at least partially around an interior edge of the thermal vessel, the main body comprising:
a mounting element comprising an inner surface and an outer mounting surface;
a first segment extending from the mounting element, the first segment comprising:
a first mounting portion extending in a first direction from the mounting element;
a first branch portion extending from the first mounting portion at an obtuse angle relative to the first mounting portion; and
a first end portion extending from the first branch portion parallel with the first mounting portion; and
a second segment extending from the mounting element, the second segment comprising:
a second mounting portion extending in a second direction from the mounting element, the second direction opposite the first direction, the second mounting portion comprising a bend;
an extension portion extending from the first mounting portion in a third direction;
a second branch portion extending from the extension portion at an obtuse angle relative to the extension portion; and
a second end portion extending from the second branch portion parallel with the extension portion;
wherein the mounting element, the first mounting portion, the second mounting portion, and the extension portion are disposed in a plane.

9. The anchoring device of claim 8, wherein:
the first segment further comprises:
a first segment outer surface extending along the first mounting portion, the first branch portion, and the first end portion; and
a first segment inner surface extending along the first mounting portion, the first branch portion, and the first end portion; and
the second segment further comprises:
a second segment outer surface extending along the second mounting portion, the extension portion, the second branch portion, and the second end portion; and
a second segment inner surface extending along the second mounting portion, the extension portion, the second branch portion, and the second end portion;
wherein the inner surface, the first segment inner surface, and a portion of the second segment inner surface form a planar inner surface.

10. The anchoring device of claim 8, wherein the mounting element is integrally formed with a stud, the stud extending from the outer mounting surface and configured to couple the anchoring device with an interior surface of the thermal vessel.

11. The anchoring device of claim 9, wherein the outer mounting surface of the mounting element is positioned on a same side as the first segment outer surface and the second segment outer surface, such that the mounting element extends outward relative to the first segment outer surface and the second segment outer surface.

12. The anchoring device of claim 9, wherein the mounting element comprises a recess configured to receive a first portion of a stud, and the outer mounting surface of the mounting element is configured to interface with a second portion of the stud.

13. The anchoring device of claim 8, wherein the plane is a first plane, wherein the first end portion and the second end portion are disposed in a second plane, the second plane offset from and parallel with the first plane.

14. The anchoring device of claim 8, wherein the third direction is perpendicular to the second direction.

15. The anchoring device of claim 8, wherein the main body further comprises a plurality of voids, the plurality of voids comprising:
a first void disposed on the first branch portion;
a second void disposed on the second mounting portion; and
a third void disposed on the second branch portion.

16. An anchoring device for a refractory material for lining a thermal vessel, the anchoring device comprising:
a main body configured to extend at least partially around an interior edge of the thermal vessel, the main body comprising:
a mounting element comprising an inner surface and an outer mounting surface;
a first segment extending from the mounting element, the first segment comprising:
a first mounting portion extending in a first direction from the mounting element;
a plurality of first branch portions extending from the first mounting portion at an obtuse angle relative to the first mounting portion; and
a plurality of first end portions, each extending from a corresponding one of the plurality of first branch portions, the plurality of first end portions extending parallel with the first mounting portion; and
a second segment extending from the mounting element, the second segment comprising:
a second mounting portion extending in a second direction from the mounting element, the second direction opposite the first direction, the second mounting portion comprising a bend;
an extension portion extending from the first mounting portion in a third direction;
a plurality of second branch portions extending from the extension portion at an obtuse angle relative to the extension portion; and
a plurality of second end portions, each extending from a corresponding second branch portion of the plurality of second branch portions, the plurality of second end portions extending parallel with the extension portion;
wherein the mounting element, the first mounting portion, the second mounting portion, and the extension portion are disposed in a plane.

17. The anchoring device of claim 16, wherein:
the first segment further comprises:
a first segment outer surface extending along the first mounting portion, the plurality of first branch portions, and the plurality of first end portions; and
a first segment inner surface extending along the first mounting portion, the plurality of first branch portions, and the plurality of first end portions; and
the second segment further comprises:
a second segment outer surface extending along the second mounting portion, the extension portion, the plurality of second branch portions, and the plurality of second end portions; and
a second segment inner surface extending along the second mounting portion, the extension portion, the plurality of second branch portions, and the plurality of second end portions;
wherein the inner surface, the first segment inner surface, and a portion of the second segment inner surface form a planar inner surface.

18. The anchoring device of claim 17, wherein the outer mounting surface of the mounting element is positioned on a same side as the first segment outer surface and the second segment outer surface, such that the mounting element extends outward relative to the first segment outer surface and the second segment outer surface.

19. The anchoring device of claim 17, wherein the mounting element comprises a recess configured to receive a first portion of a stud, and the outer mounting surface of the mounting element is configured to interface with a second portion of the stud.

20. The anchoring device of claim 16, wherein the main body comprises a plurality of voids, the plurality of voids comprising:
a first void that extends between a first branch portion of the plurality of first branch portions and a first end portion of the plurality of first end portions;
a second void disposed on the second mounting portion; and
a third void that extends between a second branch portion of the plurality of second branch portions and a second end portion of the plurality of second end portions.
